(19) United States
(12) Patent Application Publication
(10) Pub. No.: US 2017/0023911 A1
(43) Pub. Date: Jan. 26, 2017

(54) Themed Holographic Theater

(71) Applicants: Steve Russell, Reno, NV (US); Phil Nelson, Blaine, MN (US); Doug Hajicek, Minneapolis, MN (US)

(72) Inventors: Steve Russell, Reno, NV (US); Phil Nelson, Blaine, MN (US); Doug Hajicek, Minneapolis, MN (US)

(21) Appl. No.: 15/213,757

(22) Filed: Jul. 19, 2016

Related U.S. Application Data
(60) Provisional application No. 62/194,294, filed on Jul. 20, 2015.

(51) Int. Cl. G03H 1/00; G03H 1/04

(52) U.S. Cl. CPC G03H 1/0005; G03H 1/0443; G03H 2001/0055; G03H 2001/0061; G03H 2001/0088; G03H 2001/0452

(57) ABSTRACT

A themed holograph theater system and method for presenting interactive holographic imagery that presents 2D or 3D holographic imagery interactive with physical objects. The themed holographic theater system includes a camera or scanner to obtain data concerning the physical object, a projector to project images on a holographic media and a program to identify the physical object based on the camera or scanner data and control the projection of images interacting with the physical object.

### FIELD OF THE INVENTION

This invention relates, in general, to the electronic arts and multimedia collaboration areas. Specifically, this invention relates to a themed holograph theater.

### BACKGROUND OF THE INVENTION

For centuries, toys, games, and entertainment devices came in the form of replicas of real world objects and activities scaled down and organized to be manageable in a small area. However, those objects and activities operated in the real world and relied on the imagination, fanned by the product, to provide the compelling edge that stimulated, excited and even educated the user.

In the past few decades, the development of computers gave rise to electronic games and entertainment applications, which, free standing or in computer form, allowed users to engage in a fantastical world far beyond the practical limitations of physical toys. This new form is compelling and utterly portable. However, it exists entirely in the virtual world. A place that allows for only a tiny fraction of the tactile elements that so dominate our physical lives and inform our understanding.

In due course, electronic devices have come to dominate the toy and game market, and the entertainment industry in general, with “traditional” toy manufacturers struggling to bring their products into the “modern age”, and find a way to combine the virtual with real world objects. Achieving this has become the holy grail of traditional toy and entertainment product makers. Up until now, their efforts have taken the form of trying to use websites and social media to engage users in the virtual world as well as the physical. However, not at the same time. The two activities remain separate, unlinked from each other, which inevitably provides an incomplete experience.

The present invention fully integrates both the real and virtual worlds, providing an entertainment experience that relies on both worlds in real-time to provide a compelling activity that enhances the experience in a way that neither can achieve separately. Allowing full tactile engagement while stoking the imagination. Amusing, challenging and thrilling at levels not possible from either form on their own. It is the nexus of the real and virtual worlds.

As such, the present invention provides for an intimate viewer experience, in gaming and entertainment, as virtual characters or objects will appear and seem to interact with real objects (including live persons). The hearing impaired may also be fully entertained with vivid three dimension (3D) holographic imagery, which may also provide closed captioning.

### BRIEF DESCRIPTION OF THE FIGURES

The invention may be better understood by referring to the appended figure(s). The components in the figures are not necessarily to scale, emphasis instead being placed upon illustrating the principles of the invention. In the figures, like reference numerals designate corresponding parts throughout the different views.

FIG. 1 illustrates an angled perspective view of one embodiment of the system of the Themed Holograph Theater.

FIG. 2 shows a front view of an exemplary embodiment of the system of the Themed Holograph Theater including a holographic image of fireworks, presented with a racing automobile miniature.

FIG. 3 shows a front view of an exemplary embodiment of the system of the Themed Holograph Theater including a display device cradle.

FIG. 4 shows a front view of an exemplary embodiment of the system of the Themed Holograph Theater including a holographic image of racing automobile maintenance crew at a pit stop.

FIG. 5 shows a front view of an exemplary embodiment of the system of the Themed Holograph Theater including holographic images of racing automobile maintenance crew and tire smoke at a pit stop.

FIG. 6 shows a front view of an exemplary embodiment of the system of the Themed Holograph Theater including a holographic image of presentation banner text at a pit stop.

FIG. 7 shows a front view of an exemplary embodiment of the system of the Themed Holograph Theater including a holographic image of presentation banner data at a pit stop.

FIG. 8 shows an angle front view of an exemplary embodiment of the system of the Themed Holograph Theater including a holographic image of start lights.

FIG. 9A and FIG. 9B shows a front perspective view and a side perspective view of the Themed Holograph Theater including alternative constructions of the components to mount the holographic image display and the cradle for the display device.

FIG. 10 shows an open top side view of an exemplary embodiment of the system of the Themed Holograph Theater including a display device (iPhone in this case) mounted on a cradle.

FIG. 11 shows an open top front view of an exemplary embodiment of the system of the Themed Holograph Theater including a display device (iPhone in this case) mounted on a cradle.

FIG. 12 shows an open top side view of an exemplary embodiment of the system of the Themed Holograph Theater including a display device (iPhone in this case) mounted on a cradle.

FIG. 13 shows an angled open top side view of an exemplary embodiment of the system of the Themed Holograph Theater including a display device (iPhone in this case) mounted on a cradle.

FIG. 14 shows an open top front view of an exemplary embodiment of the system of the Themed Holograph Theater including a detached display device (iPhone in this case) and a cradle.

FIG. 15 shows a side view of an exemplary embodiment of the system of the Themed Holograph Theater including a physical object (a racing automobile miniature on a racing track).

FIG. 16 shows a perspective side view of another version of the Themed Holograph Theater including a display device and a second display device mounted in the canopy.

FIG. 17 shows an exploded perspective view of a device for mounting the screen of the holographic image display in the Theater.

FIG. 18 is a front perspective view of the Theater including a segment of a slot car track with two slot race cars.

FIG. 19 is a front perspective view of the Theater depicting a solid object in the shape of a tree moving across the stage of the Theater with holographic decorations.

FIG. 20 is a front perspective view of an embodiment of the Theater including a structure represented as a doll-house positioned on the stage.

FIG. 21 is a front perspective view of an embodiment of the Theater including a pair of display devices that may independently or in combination project holographic images onto the screen of the holographic image display.

FIG. 22 is a front perspective view of an embodiment of the Theater including a pair of display devices that are mounted at different angles in the canopy of the Theater and thus at different angles with respect to the screen of the holographic image display.

FIG. 23A and FIG. 23B are depictions of a Theater configured in the shape of a pyramid over an inverted pyramid with rhombus-shaped screens on each of the sides.

FIG. 24 is a schematic representation of an alternative Theater design having multiple screens forming multiple sides of the Theater.

FIG. 25 schematically depicts a perspective view of components of an alternate configuration of the Theater.

FIG. 26 schematically depicts a perspective view of an alternate configuration of the display assembly that may be used in the Theater.

FIG. 27 schematically depicts a perspective view of another alternate configuration of the display assembly that may be used in the Theater.

FIG. 28 schematically depicts a perspective view of another alternate configuration of the display assembly that may be used in the Theater.

FIG. 29 schematically depicts a perspective view of another alternate configuration of the display assembly that may be used in the Theater.

FIG. 30 schematically depicts a perspective view of another alternate configuration of the display assembly that may be used in the Theater.

FIG. 31 schematically depicts a perspective view of another alternate configuration of the display assembly that may be used in the Theater.

FIG. 32 is a flowchart providing an exemplary version of the program logic for the system to operate the Theater of the present invention.

### DETAILED DESCRIPTION

In the following description, reference is made to the accompanying drawings and figures that form a part hereof, and which show, by way of illustration, specific preferred embodiments in which the invention may be practiced. Other examples of implementations may be utilized and certain changes may be made in the relative proportions, arrangements, or configurations of the components described herein without departing from the scope of the present invention.

The present invention—called the Themed Holograph Theater (“the Theater”)—provides for systems and methods for presenting an interactive holographic imagery. The Theater relates to a product that presents 2D or 3D holographic imagery that interacts with a physical object in the Theater. The Theater may create a custom movie or animation, or data display providing information to a viewer, based on interactivity with at least one physical object in the Theater or in an associated field of view of a scanner associated with the Theater.

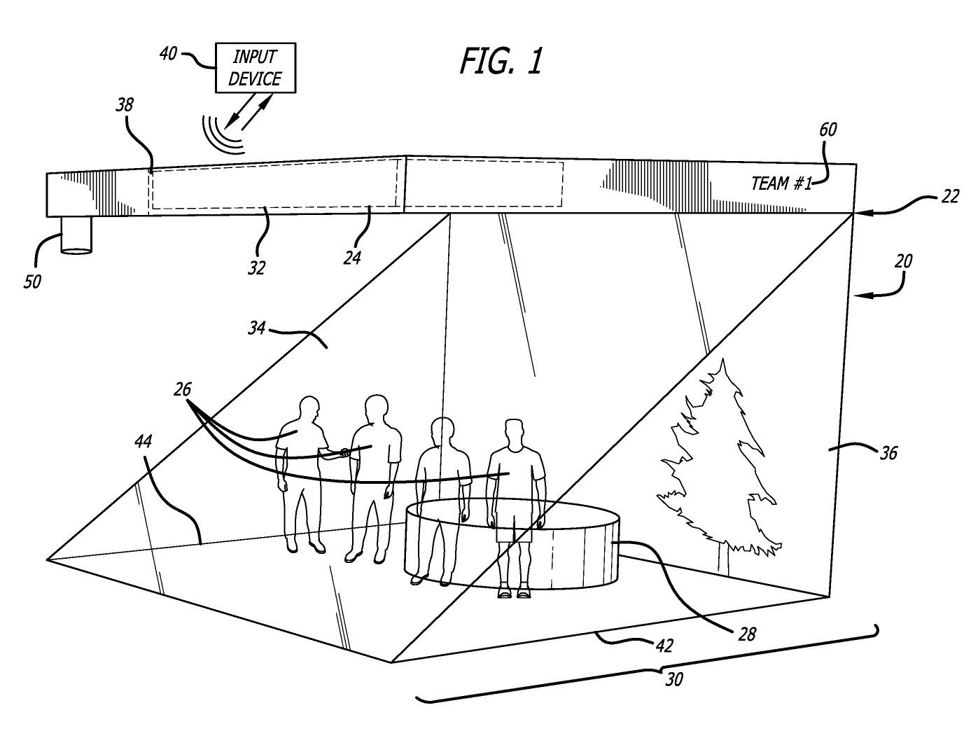

FIG. 1 illustrates an angled view of one embodiment of the system of the Theater 20. As shown, the Theater 20 may include a physical structure 22 that houses a display device 24 that controls the presentation. The presentation may be the sum of all interaction between holographic images 26 and at least one physical object 28. The presentation may run any length of time, and may run based on an automated process. The presentation may be adjusted in real-time based on setup configurations; entry/exit of physical objects onto a stage 30 of the Theater 20; interaction between multiple display devices 24, camera or monitor or scanner devices 32, or other factors or components. The Theater 20 also includes a holographic image display 34, for example a transparent reflective surface placed at the front of the stage or between the stage 30 and the intended viewer. The holographic image display 34 is preferably a screen made of transparent but reflective materials such as plastic or glass. The Theater 20 may also include a backdrop 36 which may be as simple as a cardboard sheet with or without setting images, or as complicated as a monitor or television screen interactively coupled to the display device 24. The backdrop may also include speakers (not shown) for providing audio output. In some embodiments, it is contemplated that an input device 40 may be used to adjust the presentation's configurations, programming, preferences, etc., of at least the display device 24 and the backdrop 36, either by wired control or preferably wirelessly, as depicted.

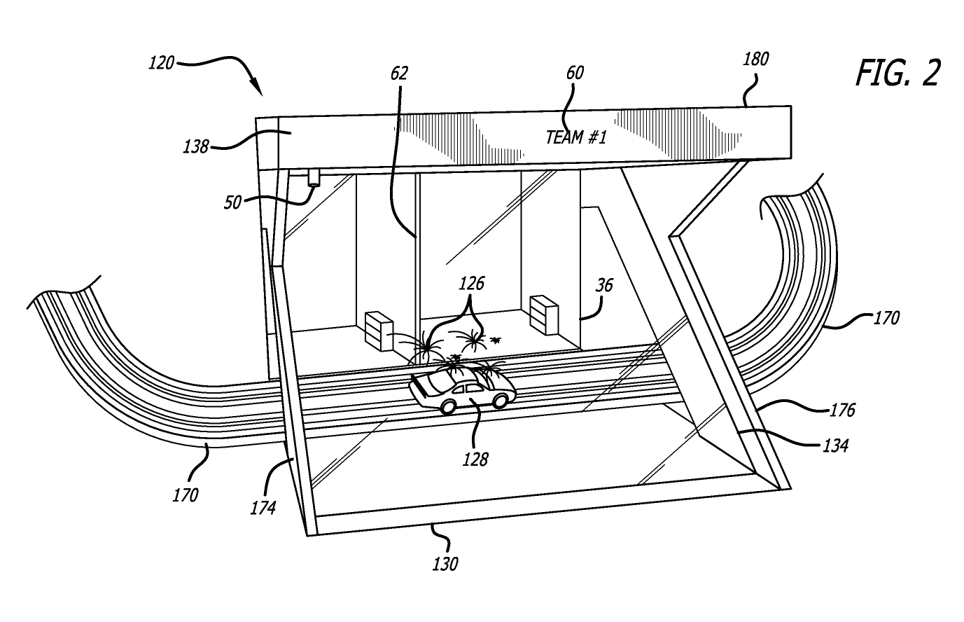

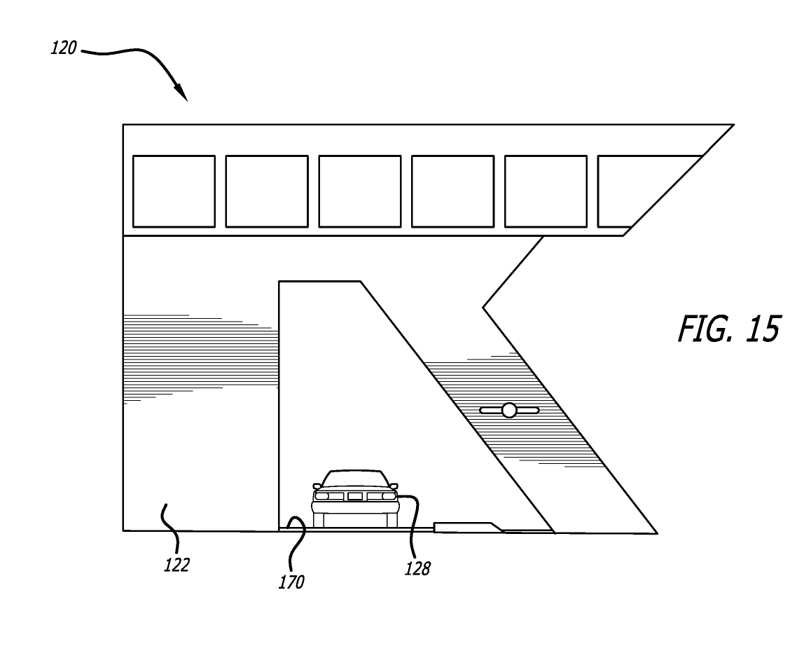

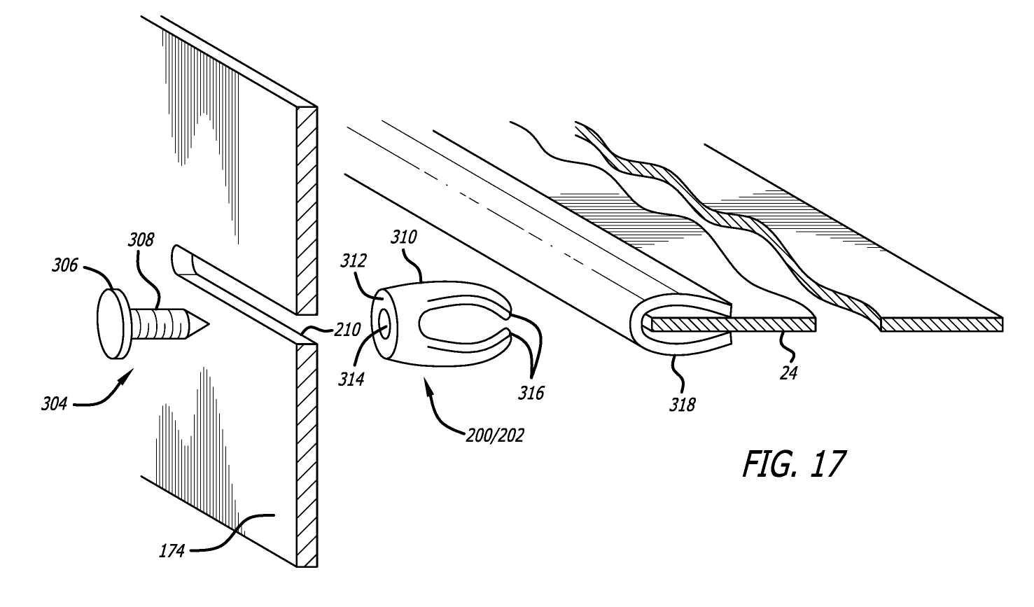

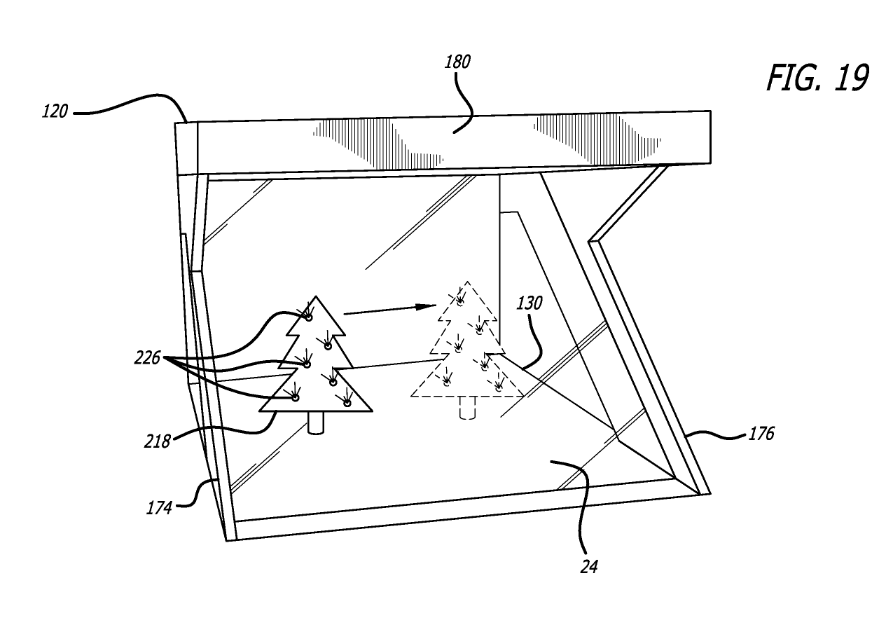

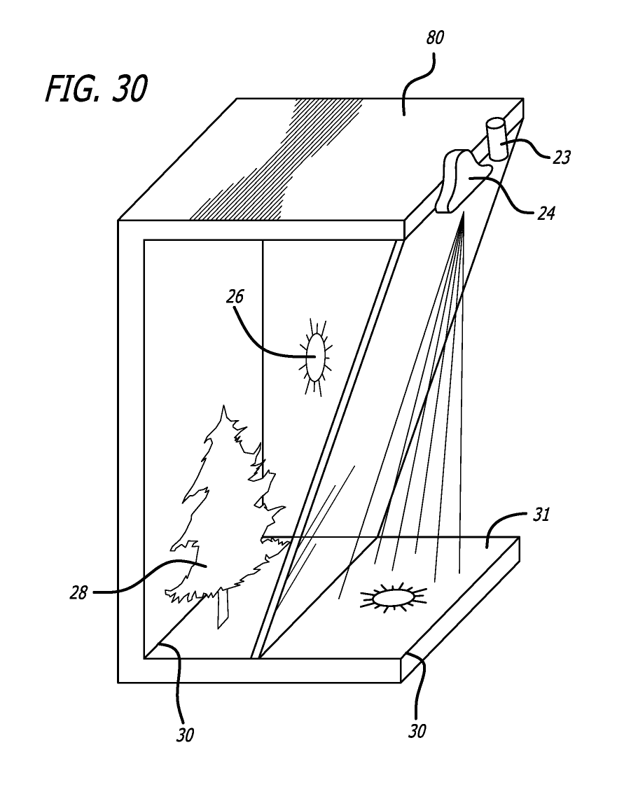

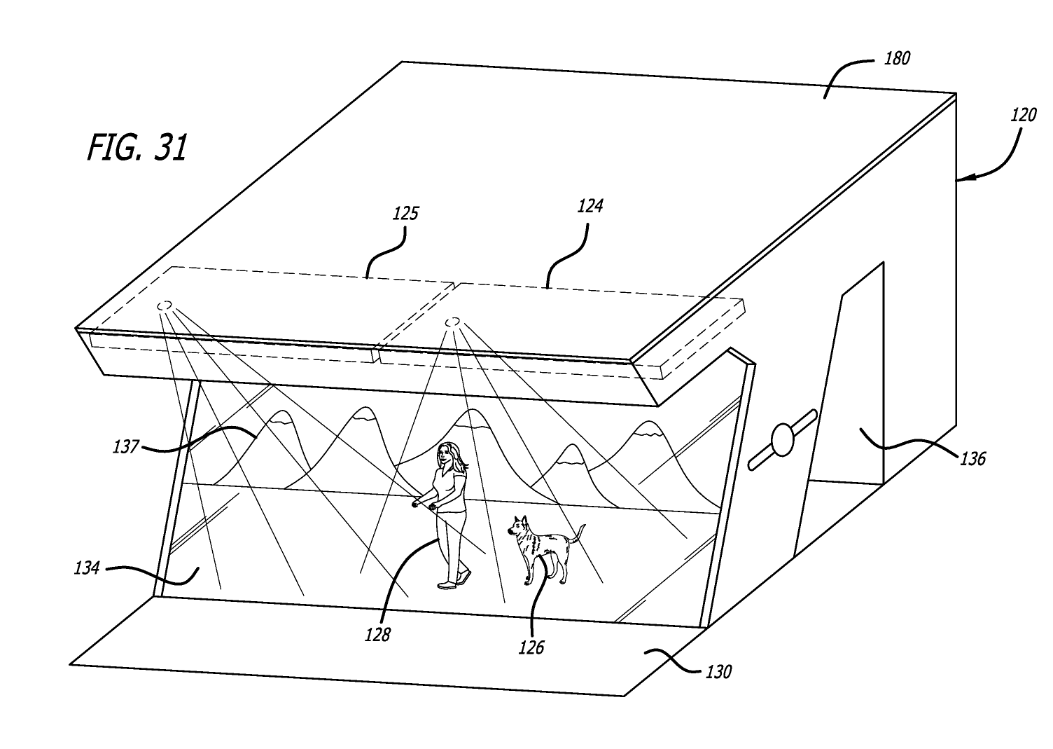

The physical object 28 may be a solid object made of any material that is identifiable by the display device 24, the monitor/scanner device 32, or other device configured to capture data relative to the physical object 28, such as its shape, color, decoration(s), or other means of identification including for example a barcode, uniform product code (UPC), quick response (QR) code or a radio frequency transponder operative with an associated data file for the respective solid object 28. The physical object 28 may be fixed or mobile in the Theater 20. Alternatively, the physical object 28 may be outside of the Theater 20 but in the field of view of an associated scanner whereby the physical object 28 may be identified by the system and its image may then be projected as part of the holographic display on the stage 30 of the Theater 20. As depicted in FIG. 1, the physical object 28 is simply shown as a short column segment. Other figures described below show the physical object 28 as a model car (FIGS. 2-8) or as a themed toy (FIG. 16), a plant or tree (FIGS. 18 and 30), a structure (FIG. 20), or a doll (FIG. 31) for purposes of describing the present invention. It should be appreciated, however, that the physical object 28 incorporated into the presentation on the stage 30 of the Theater 20 can be any variety of physical items from toys to vehicles to animals and humans, with the Theater 20 being appropriately scaled in size and dimensions. Where the physical object is a toy, for example, as described herein, the present invention contemplates having the toy be characterized by an identification characterizer, which may be a bar code, uniform product code, quick read code, radio frequency identification device or image code, that may be detected by a monitor or scanner device to then identify an associated data file in a memory associated with the Theater system, the data file having information concerning the physical characteristics of the physical object (size, shape, color, surface features, etc.), that may be incorporated into the control of the holographic media projection.

In some preferred embodiments, the holographic images may be produced from live action video, animation, computer generated graphics, or any other means that results in a final digital image that can be projected or reflected on the holographic image display 34 to appear in the space above the stage 30. The final digital images for the holographic projection are provided either live via a live video streaming feed or streamed from a database. The database can be on a local device that is also the projector like a smartphone or on a hardware server that is accessed via a network, an intranet or the internet, or a cloud based system. The holographic images 26 may be fixed or moving based on the projections of the display device 24, or another device, that projects them onto the holographic image display 34, such as a transparent reflective surface screen. These virtual 2D or 3D images may interact with or add to the background provided by the backdrop 36 in proximity to the physical object(s) 28 to create the presentation. The holographic images 26 may be projected on, or around the physical object 28 as observed by the audience. The holographic images 26 may also be made to appear to penetrate a solid object, appear from within a solid object in the Theater 20, including or in addition to the physical object 28, or move outward from a solid object, in some embodiments. For example, an image of a soul could appear to rise from a body, or an image of a bullet could appear to pass through a wall, or a driver could appear in and exit from a model car, as described below.

The holographic images 26 may be projected onto the physical object 28 and be made to move away from the physical object 28 as the holographic image projection transitions onto the clear laminate or screen. The screen of the holographic image display 34 may be a media on which the holographic images are projected/reflected by the display device 24, or another projection device (not shown). The holographic image display 34 may be constructed of plastic laminate, glass, resin or other reflective material. The holographic image display 34 may be attached to the Theater 20 at the top of the backdrop 36 and a forward edge of the stage 30. The holographic image display 34, and may be supported by additional structures, for example a cradle support structure 38 to hold the display device 24 above the stage 30 and in front of the backdrop 36. In some embodiments, there may be one or more holographic image display 34 screens and they may be located in front or behind the stage 30, or at one or more spots in or around the Theater 20. In some preferred embodiments, up to ten clear holographic image display 34 screens may be used to present ten corresponding holographic images 26. The different holographic image display 34 screens may be located in ten different spots in or around the Theater 20.

The stage 30, backdrop 36 and cradle support structure 38 components of the Theater 20 may be decorated to provide a themed background for one or more physical objects 28. In some preferred embodiments, the components of the Theater 20 may be constructed of plastic, metal, paper, or foam core paper laminates. In some embodiments, the Theater 20 may include a stage 30 interactive with the physical object 28, as for example in the embodiments of FIGS. 2-6, the stage 30 is a section of a slot car racing track. The stage 30 is generally an area of the Theater 20 where the physical object(s) 28 may be located or they may pass into or through. The stage may be exposed to a camera or scanner device 32 that may be a component of, or an additional element positioned near, the display device 24.

In some embodiments, the Theater 20 may have two open opposite sides at the right and left edges, 42 and 44 respectively, of the stage 30 as viewed by a user. In other embodiments, all of the Theater's sides may be a holographic image display 34 comprised of a thin acetate reflective surface for projecting crisp holographic imagery. The thin acetate surface may be 1/32 of an inch in thickness, and may be supported on at least two of its sides, top and bottom edges. In some embodiments, the display device 24 may project the holographic images onto one or more of the sides of the Theater 20.

In some embodiments, the display device 24 is used to present the holographic images 26. For example, the display device 24 used may be a cell phone, dedicated LCD or plasma screen, iPad or any smart tablets, or other type of image projecting display device. Alternatively, the Theater 20 may be provided as a complete system including a built in projector for the display device 24 that has a data port, power supply and memory that may be loaded with or adapted to upload a particular theme, setting and animation, for example, a Theater for simulating racing that has the identification data for various NASCAR and/or Formula 1 module cars, a different Theater that has the identification data for one or more MATTEL or TYCO toy story themes, another that has MARVEL or DC COMICS themes and another that has POKEMON themes. The smartphone/cell phone may be an iPhone, Samsung or any other similar smartphone. The display device 24 may also be any other device that would allow projection of a presentation; and which may also allow data storage, scanning of physical objects; data or programming or have inputs providing the functions and other functions in separate components or in a combination of components providing the foregoing functionalities. The projector of the display device 24 may be selected from the group consisting of a liquid crystal display screen, a light emitting diode display screen, a movie projector, a smartphone, a tablet computer, a television and a monitor

The display device 24 may be placed by the user in a separately provided themed physical structure. For example, the user may download an application to a smartphone or tablet computer and then place the smartphone or tablet computer in the cradle support structure 38 of a Theater 20. In some preferred embodiments, the display device 24 may project live action or animated holographic images 26 onto a clear laminate placed at any area around or near an identifiable physical object 28 to function as the holographic image display 34. The identifiable physical object 28 may be fixed or mobile. In some embodiments, the holographic images 26 may be projected in a manner responsive to the physical location or movements of one or more of the identifiable physical object(s) 28. For example, as the physical object 28 moves through the theater 20, the holographic images 26 will appear to move with and interact with the physical object. As another example, if the physical object is a doll, a holographic image of a puppy may be projected by the display device 24 so that the holographic puppy plays with the physical object doll. The physical object 28 may be any tangible object or a real live being, such as a person, an animal, or fish, but more likely a toy, model, game piece, collector card or other type of mechanical apparatus.

In some embodiments, the display device 24 may be affixed at an angle facing downwards in the cradle support structure 38, if placed on the top of the Theater 20, or may be facing upwards, if placed towards or in the stage 30 or floor of the Theater 20. In other embodiments, the display device 24 may be placed in a cradle that may be fixed or adjustable allowing variation of the angle to the screen, to facilitate an optimum field of vision for the audience.

In some embodiments, the display device 24 may be affixed at an angle ranging from 30 degrees to 60 degrees in relationship to the reflective surface of the holographic image display 34. However, mirrors may be used to project the holographic images 26 or their reflection onto the holographic image display 34. Cameras in smartphones may also be used for image recognition of the physical object 28 to overcome the optimum projection angle. Double layered acetate surfaces for the holographic image display 34 may be used to create a twin hologram. For example, the same holographic image 26 may be reflected onto each of the layers of the acetate surface by different display devices 24. Each of the different display devices 24 may also display the holographic image 26 with different visual characteristics.

In one preferred embodiment, a monitor device, such as a scanner device 32, may be used to monitor and detect the movements of the physical object 28. The monitor device or scanner device 32 may detect the movements of one or more physical objects 28, and the detected data may be used in the system to control the display device 24 to project the holographic images 26 in a responsive manner to the movement of the physical object 28. The monitor device or scanner device 32 may be attached to or even be a part of the display device 24, for example if the display device 24 is a smart phone the scanner device 32 may be the camera of the smart phone. Additionally, one or more central computing input devices 40 may be used to process the scanned data, or to control any or all of the display device(s) 24 or monitor device(s) such as the scanner device 32. Thereby, the virtual holographic images 26 may be made to appear to interact with the physical object(s) 28.

In some preferred embodiments, the presented holographic images 26 may be changed in response to a change in a physical attribute of the physical object 28 or background on the backdrop 36 being detected or monitored. For example, the scanner looks at an object (2D or 3D) providing a data output that is processed and returns the assigned and related media for playback. The recognition object can be the backdrop, 2D image or even a 3D physical object. The scanner will look for whatever is the trigger object in the given setup, for example, an item in the backdrop, another object such as a doll or some other physical object placed in the Theater 20. For example, if the detected physical object(s) 28 change in number, color, any other physical characteristic, the presented holographic images 26 may also be altered in response. The same behavior may also be applied to changes in the physical characteristics of the background on the backdrop 36 of the Theater 20. For example, if the background of the Theater 20 changes from elements depicting a beach setting to a forest setting, the presented holographic images 26 may change from images representing beach tables and chairs, etc, to images representing forest trees, plants, etc. Hence, the number of images, their colors, or the nature of their interaction with the physical object(s) 28 may morph based on the nature of the physical object(s) 28, or the background(s), or a combination thereof.

In some embodiments, several possible configurations related to the location of the holographic images 26, their visual nature, interaction with the physical objects 28, their sizes, shapes, angle of appearance, etc., may be modified in real-time, during the presentation. One or more of these configurations may be adjustable in real-time using the display device 24, the monitor device or scanner device 32, or another separate device. The combination of the display device 24, the monitor device or scanner device 32, or other separate devices may be interconnected to each other and/or to an input device 40 using hardwiring, a wireless network, Bluetooth type of connectivity, infrared data transfer or other means of data connection.

In some embodiments, a first holographic image 26 produced by a first display device 24 may change in visual nature and character in response to the change of the attributes of a second holographic image 26 produced by a second display device 25 (discussed below) operating within the same Theater 20. The visual nature of the first holographic image 26 may also change in response to the change of position, location, nature, or other physical characteristics of the combination of the first and second physical objects 28. Furthermore, the visual nature of the first holographic image 26 may also morph in response to the change in the background of the Theater 20. In some embodiments, the detection of changes of any of the physical characteristics of the first holographic image 26, the second holographic image 26, the background, or any combination therefore, may be accomplished by one or more monitor devices or scanner devices 32.

In some embodiments, a trigger image or physical object 28, which is physically placed within the Theater, is scanned as a 2D or 3D image. An output media of the scanner device 32 may be stored in an image database or server (local device or cloud base) of an input device 40 with a reference to a form of output media (text, graphics, video, image, audio, website, application launch). In some embodiments, a separate detection device 50, responsible for handling data for all or any of the scanned images, may operate using an image recognition software algorithm. In these embodiments, the separate detection device 50 may be connected to one or more of the monitor device(s) or scanner devices 32, and as such the monitor device(s) or scanner devices 32 may be utilized to scan the space defined by the Theater 20 looking for a trigger image or physical object 28. In the event that a scanned image of the trigger image or physical object 28 is located within the image database on the server input device 40 or the detection device 50, the separate input device 40 or the detection device 50 may transmit the assigned media output to the display device 24 to generate the holographic image projection. This media output may then be displayed on and by the display device 24 (phone screen, LCD monitor, etc.), or projected onto the hologram screen(s) of the holographic image display 34. The output media may be interactive with one or more of the physical objects 28 and with the Theater 20. For example, placing a doll within the Theater 20 may trigger a media output of an animated hologram puppy to be displayed on a display device or projected onto the holographic image display 34 of the hologram screen. As the physical location or position of the doll changes within the Theater 20, the visual characteristics, location of image display or project, or any other attribute of the output media of the animated puppy image would change as a result of the movement of the doll as the detected physical object 28. As another alternative, the scanner 32 may detect that the doll is being moved by the hand of the user, and the image displayed could be modified by the input device 40 to mask the features of the hand moving the doll. Alternatively, the physical object 28 could be detected by a scanner device 32 in a space outside of the stage 30 of the Theater 20, and the image of the doll would be projected by the display device 24 as one of the holographic images 26, without displaying the hand moving the doll.

As depicted in FIG. 1 and as described above, an example system configuration in one embodiment may comprise a Theater 20 having a stage 30, a holographic image 26 reflection, a camera or scanner device 32, a projector or display device 24, a holographic image display 34 for example a reflective surface for a hologram, and a trigger physical object 28 or an image on a backdrop 36. The embodiment may also comprise a server input device 40 (local and/or cloud based) and/or a detection device 50 either or both of which may include a database (local and/or cloud based). Also, in these embodiments, the server input device 40 and the database may be running on the same computing device or may be connected over a network.

The Theater 20 may also be used with augmented reality programs. Augmented reality programs may be controlled via hand-held devices or other devices. The Theater 20 may be capable of creating a very intimate viewer experience by allowing the projected holographic images 26 to appear in any surrounding space to the viewers, thereby allowing the viewers to be in the middle of the action.

The Theater 20 may comprise a structure with real walls above the confines of the stage 30 that the hologram images 26 may be made to appear to pass through. The Theater 20 may be made to look like scaled down private houses, buildings such as offices, warehouses, schools or recreational facilities or event locations such as a racetrack or baseball stadium. The Theater 20 may utilize reflective glass, or clear Lexan, acetate, clear polyester, polycarbonate, plastic, PVC, or any clear or transparent material to create a ghostly image. The Theater 20 may utilize separate internal lighting that may interact with the presentation.

The Theater 20 may also be used as an alarm clock, a virtual aquarium, or a miniature movie theater. As a movie theater, the Theater 20 may be used to watch regular movies projected or displayed on the backdrop 36, TV programing, sports, comedy and all digital media. The Theater 20 may be used as or with Halloween toys, Christmas Toys, Holiday Toys, and can be used with licensed characters from any toy or entertainment company the images of which are stored in the database so that they may be recognized by the scanner device 32 and/or the input device or detection device 50.

The Theater 20 may be used for commercial purposes such as advertising and product tie-ins. The Theater 20 may be used as giveaway items from advertisers and be used as actual product boxes, food boxes, beverage boxes, fast food boxes, pizza boxes etc. The Theater 20 may be designed to have a tabletop video game theater complete with interchangeable object recognition and interaction and point mapping for game play that is totally unique to the present system. Holographic board games may include, for example, classic board games like BATTLESHIP or MONOPOLY. The Theater 20 may also include interactive game play pieces, point mapping, augmented reality, object recognition, and interchangeable game boards.

The Theater 20 may also be programmed for used for hybrid holographic video games wherein the gameplay action is confined to the boundaries of the Theater 20. These boundaries may range in size from that of a small table top video game theater to large sized room theaters and beyond. An outdoors type of a Theater 20 may be round, squared, or have any other outside geometrical shape and size. It is contemplated that micro sized Theaters 20 may also be equally functional.

The entire Theater 20 may also be constructed of almost an entirely clear material for unobtrusive views from almost 130 degrees top to bottom and side to side.

Some Unique Features of the Theater 20 and the system of the present invention may include:

(1) An enjoyable themed programming theater experience.

(2) Special stage backgrounds may be used to trigger certain movies or animation automatically.

(3) Special objects placed in an open ended stage may trigger special movies and/or animation automatically lined up to objects placed on stage.

(4) Objects may appear real using real actors or cartoons appearing to walk and touch the stage floor.

(5) Point mapping can appear and line up automatically with stage backgrounds and/or objects placed on the stage.

(6) The Theater may be portable, foldable, take apart and store, and may be constructed of lightweight materials.

(7) The holographic images may be in full color.

(8) The holographic images may be crisp and bright.

(9) Specially made objects may trigger specific holographic movie or program, or the interaction theater may create holographic point mapping on small objects using a camera to recognize a specific object even if the object is moving.

FIGS. 2 through 15 show examples of embodiments of the Theater 120 and its alternate components. The embodiments of FIGS. 2-8 portray a slot car racing application where the physical object 28 is a slot car and the theme of the Theater 120 is a pit stop or garage that may be depicted on the backdrop 36. FIGS. 2 through 7 illustrate real hologram images 26 as they appear in this embodiment of the Theater 120 to the viewer. This embodiment has the dimensions of 8 inch×8 inch×12 inch theater, and also features photo real outside graphics 60 on its skin or exterior surfaces of the canopy 80 containing the cradle support structure 138. The stage 130 can be back dropped by two real looking 1/64 scale garage images 62 with scaled interior details.

This embodiment of the Theater 120 provides for a highly enhanced presentation of slot automobile racing where the physical object 28 is an automobile/race car 128. Not only does a miniature holographic pit crew automatically line up with the position of the automobile/race car 128 using augmented reality and object recognition, point mapping is used for depicting tires coming off and going back onto the automobile/race car 128. This embodiment also features holographic start lights and pit timing displays. The depiction of the virtual pit crew working on the 2 inch long automobile/race car 128 is brought to life through this embodiment.

FIG. 2 shows a front view of an exemplary embodiment of the system of the Themed Holograph Theater 120 including a holographic image 126 of fireworks, presented with a physical object, a miniature slot car or race car 128. The Theater 120 of FIG. 2 is constructed under and around a section of a slot car track 170, which itself is generally built on a table or other support structure (not shown). The Theater 120 includes a stage 130, which includes a segment of the slot car track 170. The slot car track 170, in the exemplary depiction, accommodates two race cars although only one, race car 128, is depicted in the Figure. Each race car 128 is individually identifiable by the system as described above, either by use of an optical scanner device 32 or detection device 50 to identify the dimensions and color of the race car 128, or by one of the other means of identification described above. The Theater 120 includes a holographic image display 134 mounted between two end panels 174, 176 and extending up from the front edge of the stage 130 to the canopy 180 behind the cradle support structure 138. As depicted, the holographic image display 134 is mounted to form an acute angle to the surface of the stage 130. The acute interior angle may be formed in the range of about thirty degrees to seventy five degrees, and preferably in the range of about forty five degrees to sixty degrees. The holographic image 126 of fireworks may be projected onto the holographic image display 134 using a projector or smartphone such as an APPLE I-Phone or a SAMSUNG GALAXY smartphone (not shown) placed in the cradle support structure 138 forming a portion of the canopy 180 above the Theater 120.

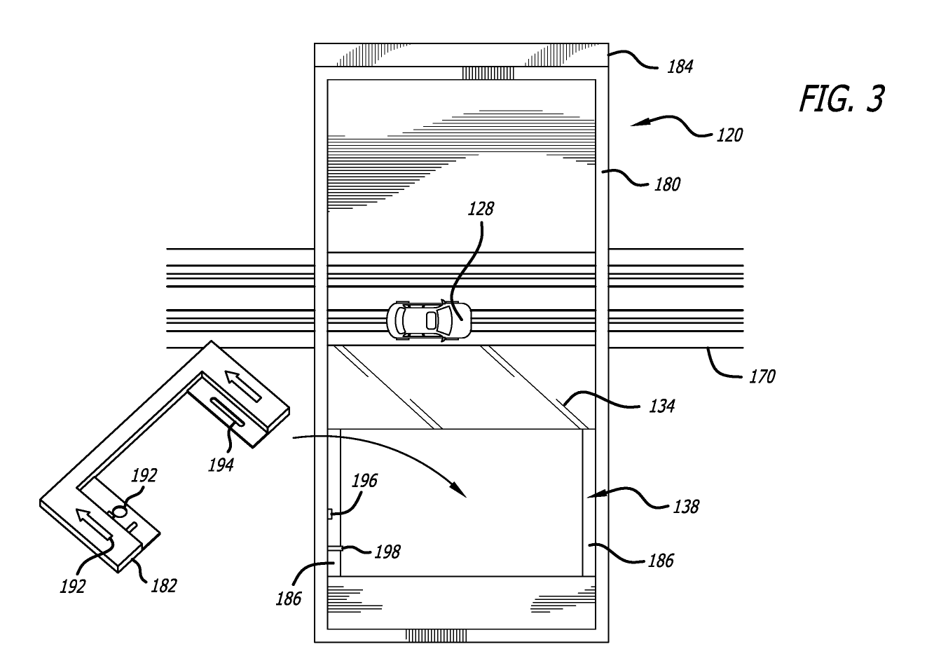

FIG. 3 shows a top view of an exemplary embodiment of the system of the Themed Holograph Theater including a display device cradle 182 that may be used to place a smartphone (not shown) to function as the display device 24 (of FIG. 1) into the cradle support structure 138 built into the canopy 180. As depicted in FIG. 3, a top portion 184 of the canopy 180 is pivoted on its back edge upward to expose the internal structure of the cradle support structure 138. The cradle support structure 138 includes ledge 186 to support the display device cradle 182, as well as the display device itself, in the canopy 180 with a screen of the smartphone facing downward toward the stage 130 [FIG. 2], so that images displayed inverted on the screen of the smartphone will project onto the holographic image display 134 angularly placed between the smartphone and the stage 130. The display device cradle 182 may include graphics 190 to assist the user in the placement and orientation of the smartphone in the display device cradle 182. Also, the display device cradle 182 may include cutout 192 for the on button and cutout 194 for the camera and microphone of the smartphone. The configuration of the canopy 180 may optionally include wiring 196, 198 to connect to the power and data port and microphone port, respectively, of the smartphone.

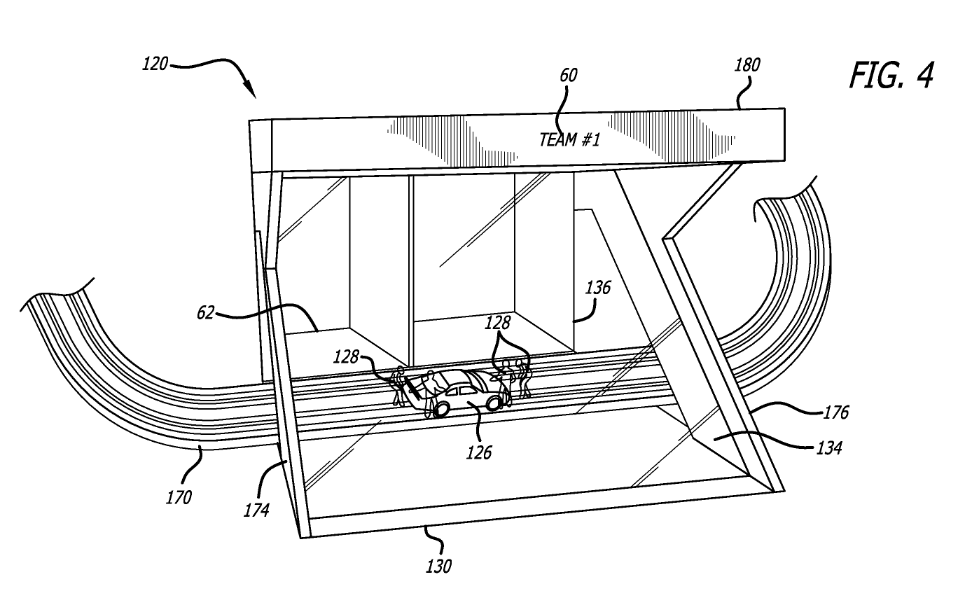

FIG. 4 shows a front view of an exemplary embodiment of the system of the Themed Holograph Theater including a holographic image 126 of racing automobile maintenance crew in front of a graphic display 62 of a garage conducting a pit stop for a race car 128 during a racing event. The graphic display of the garage is incorporated onto or projected onto the backdrop 136 of the Theater 120. The race car 128 is the physical object that is identified by the system to trigger the holographic projection of the pit crew holographic images 126. The system is configured to identify the exact location of the physical object race car 128 and adapt where the pit crew holographic images 126 are positioned and displayed to match the appropriate activities to service the race car 128 during the pit stop.

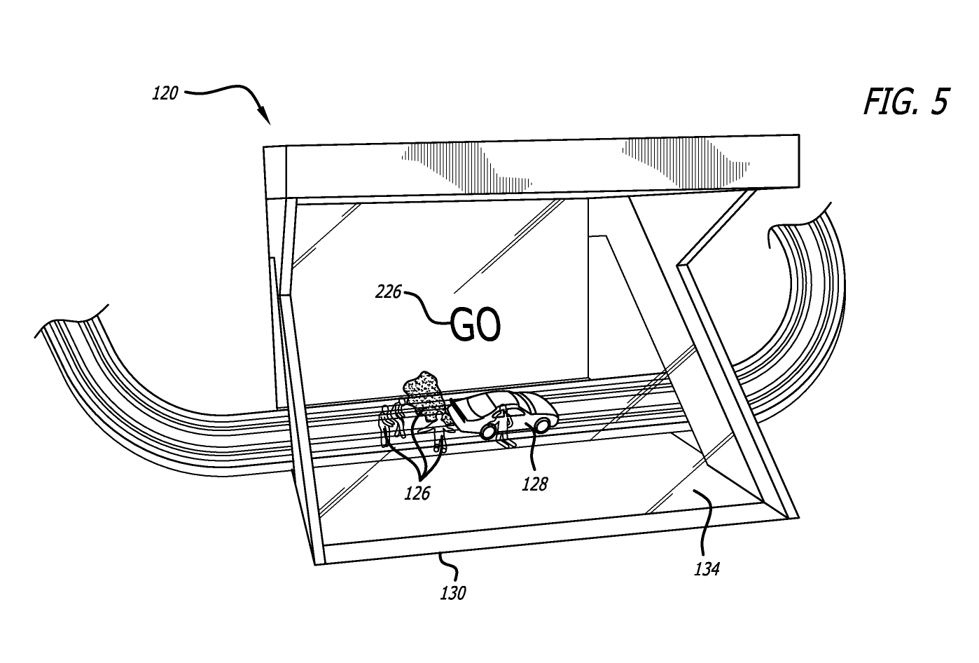

FIG. 5 shows a front view of the Themed Holograph Theater of FIG. 4 with the physical object race car 128 accelerating out of the stage 130 of the Theater 120, including holographic images 126 of the racing automobile maintenance crew and a holographic image of tire smoke appearing to emanate from the tires of the race car 128, as well as images of tires removed from the race car 128 during the pit stop. The holographic image 226 projection may also include graphics depicted as the word “Go” in FIG. 5, to notify the operator of the slot car that it is time to exit the pit stop. As may be appreciated from a review of FIGS. 4 and 5, the projection of the holographic images 126 plays out as a two or three dimensional action sequence projected onto the screen of the holographic image display 134 by the smartphone (or a tablet computer, etc.). The images displayed on smartphone are juxtaposed on a black background so that only the images of the holographic characters, animation and graphics are reflected by the screen of the holographic image display 134 and thereby visible by an operator, user or observer.

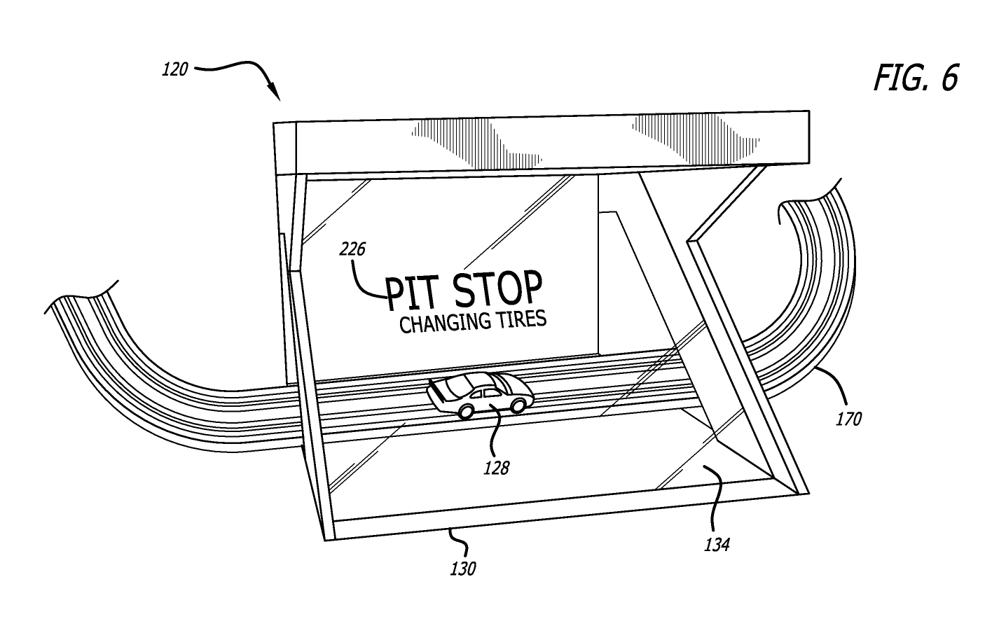

FIG. 6 shows a front view of the Themed Holograph Theater including a holographic image of a graphic such as a presentation banner text graphics as holographic images 226 that may be displayed on the holographic image display 134 at the beginning of a pit stop or alternatively the banner text graphics holographic images 226 may be displayed as a result of the race car passing through the stage 130 to let the operator controlling the race car 128 know that a pit stop to change the tires is required in the particular race simulation.

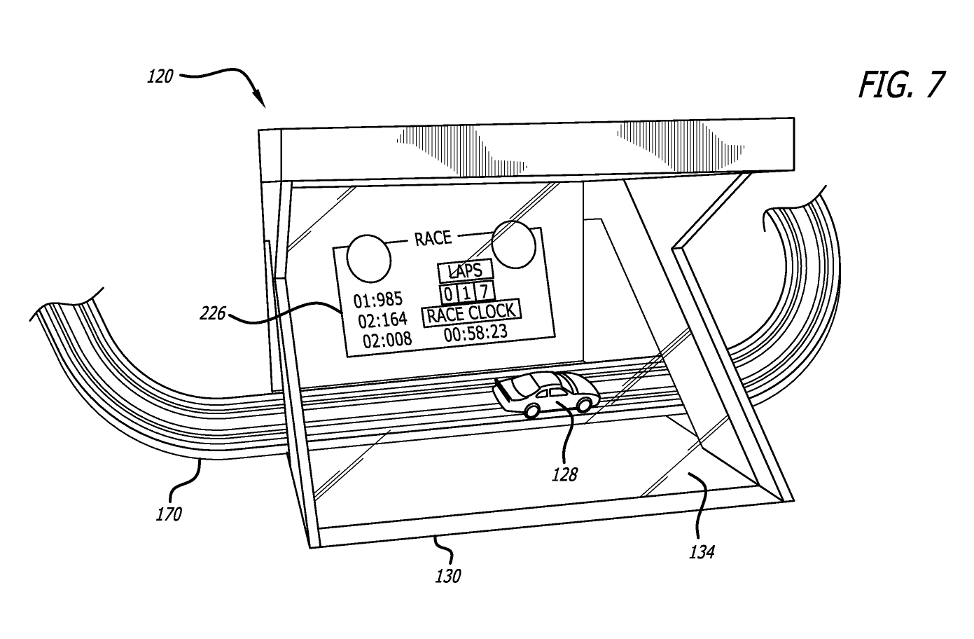

FIG. 7 shows another front view of the Themed Holograph Theater including a holographic image of text graphics holographic images 226 that may be presented for example at the end of a simulated pit stop or as a particular race car 128 passes through the Theater 120 to graphically display race data, for example lap times or a stopwatch for the pit stop, a lap counter and race clock showing the duration of the race event.

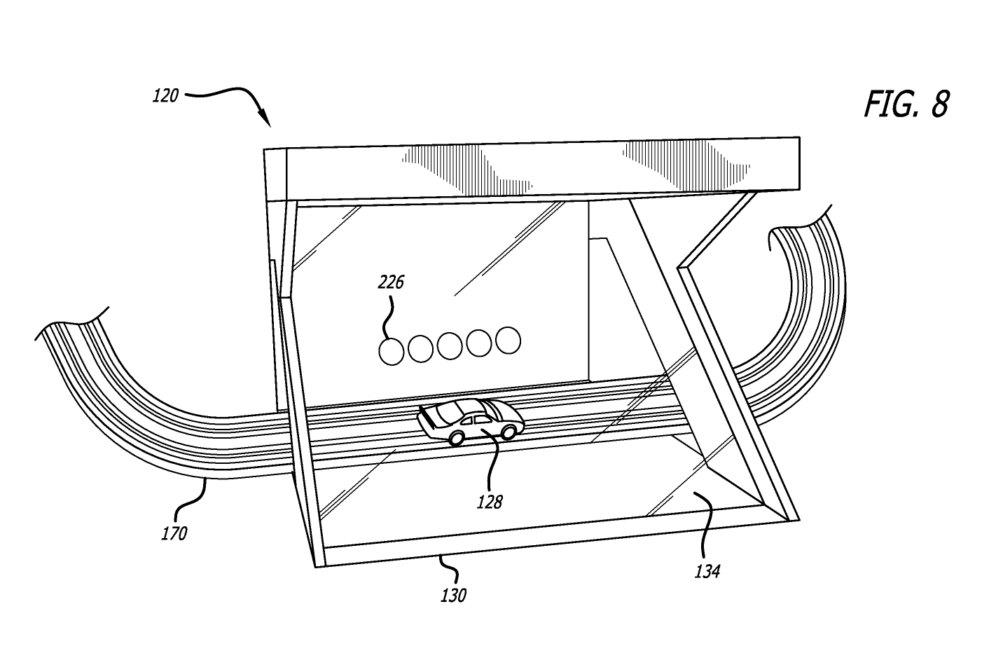

FIG. 8 shows an angled front view of an exemplary embodiment of the system of the Themed Holograph Theater 120 including a holographic image graphics holographic images 226 depicting racing countdown start lights that may sequentially change color to notify the operator controlling the race car 128 when it is time to start the race or exit the pit stop.

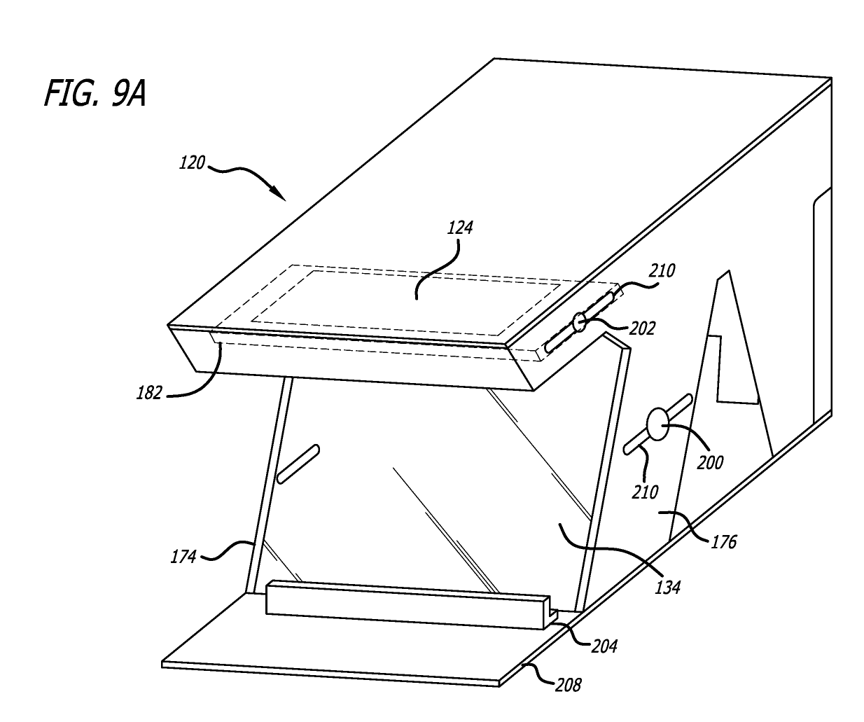

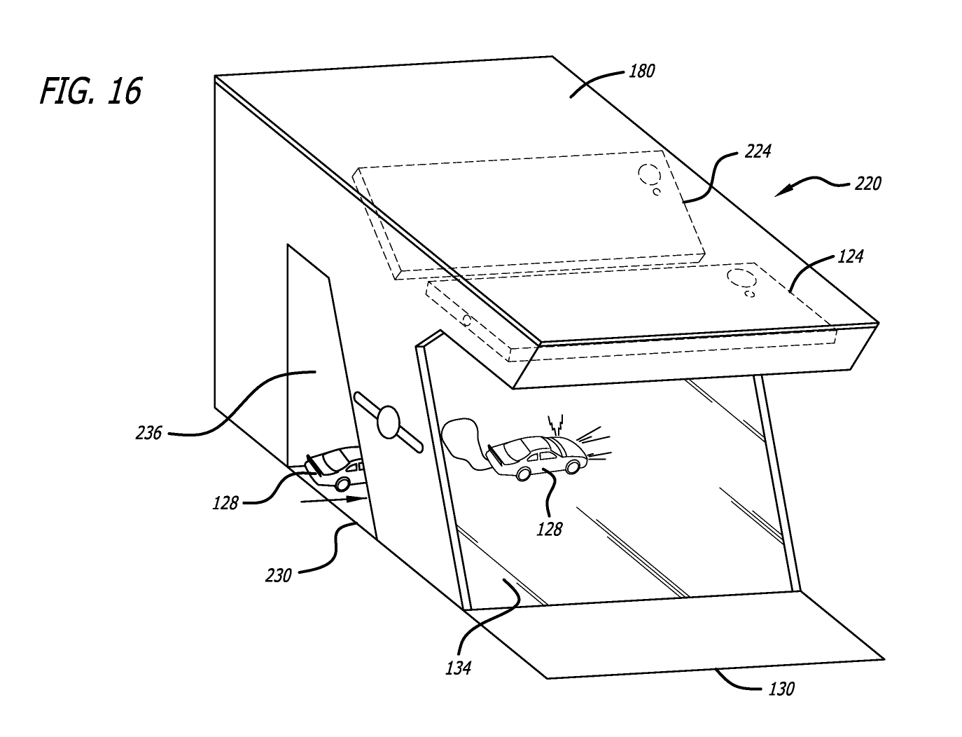

FIG. 9A and FIG. 9B show a front perspective view and a side perspective view of the Themed Holograph Theater 120 including alternative constructions of the components to mount the holographic image display 134 and the cradle 182 for the display device 124. As depicted, the end panel 176 (as well as end panel 174), include an adjustable screen mounting device 200 for pivotally and movably mounting the holographic image display 134, as well as a cradle mounting device 202 for pivotally and movably mounting the cradle 182 carrying the display device 124. The adjustable screen mounting device 200 allows the holographic image display 134 to be rotated and secured between two position locks 204 and 206 [FIG. 9B] fixed to the base or floor surface 208 of the stage 130. The end panels 174 and 176 include slots 210 for repositioning the adjustable screen mounting device 200 horizontally. Similarly, the end panels 174 and 176 include second slots 210 for repositioning the cradle 182 horizontally. One configuration for the adjustable screen mounting device 200 and/or the cradle mounting device 202 is detailed in FIG. 17 and described in greater detail below.

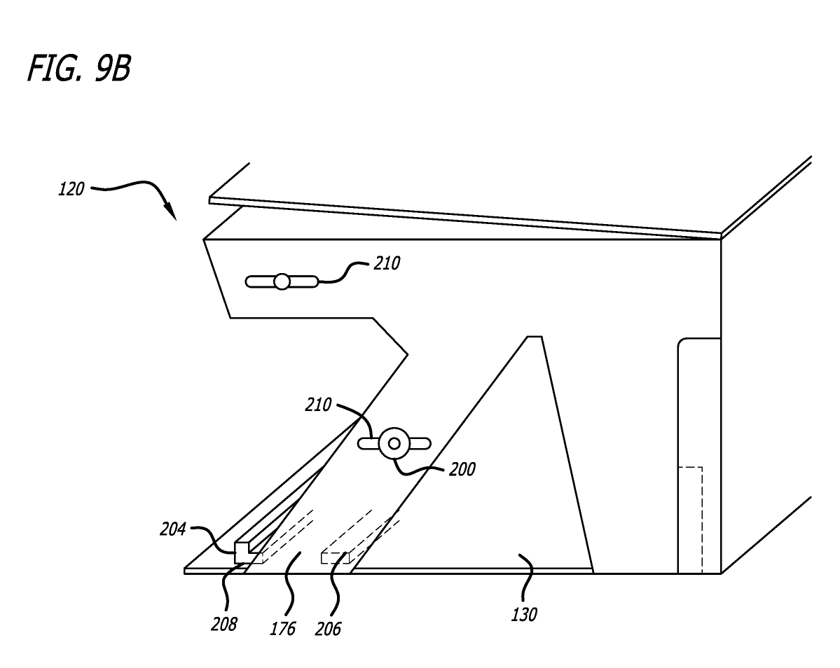

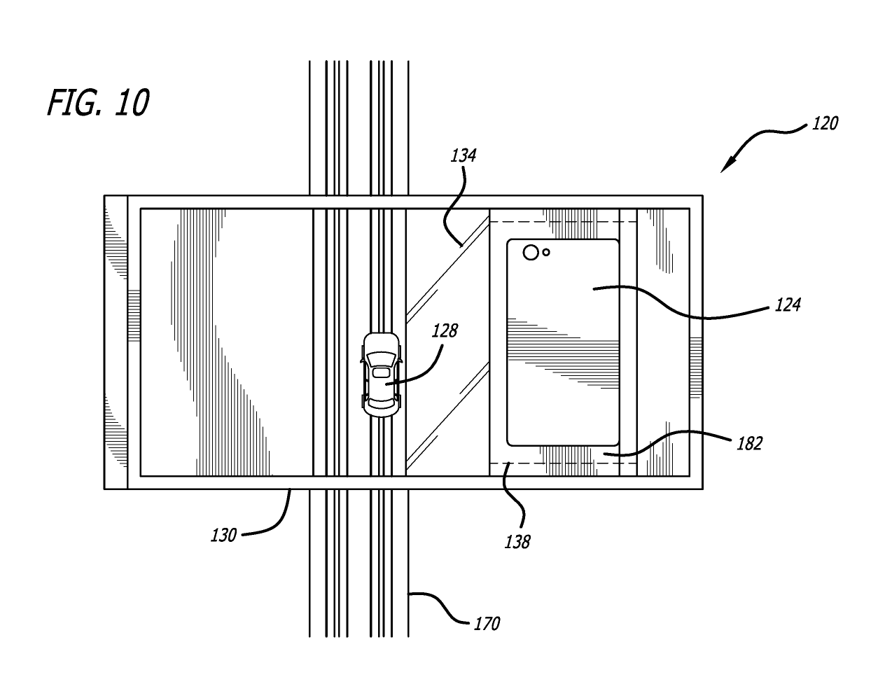

FIGS. 10 and 11 shows an open top side view and open top front view, respectively, of an exemplary embodiment of the Themed Holograph Theater 120 including the display device 124 represented as an iPhone, mounted in the display device cradle 182 and placed within the cradle support structure 138. The depiction also shows the race car 128 sitting on the slot car track 170 on the stage 130 of the Theater 120. The view also depicts the top edge and a portion of the screen of the holographic image display 134, which is mounted at an acute angle to the stage 130, with the screen of the iPhone facing toward the exterior side of the screen of the holographic image display 134. In this configuration, images displayed inverted on the screen of the iPhone project onto the screen of the holographic image display 134 and appear as holographic images around or in front of the race car 128, from the perspective of the viewer of the Theater 120. In addition, the front facing camera of the iPhone can be used as the scanner to image identify the individual race car 128 for the system to calculate the position of the car for purposes of appropriately positioning the holographic characters.

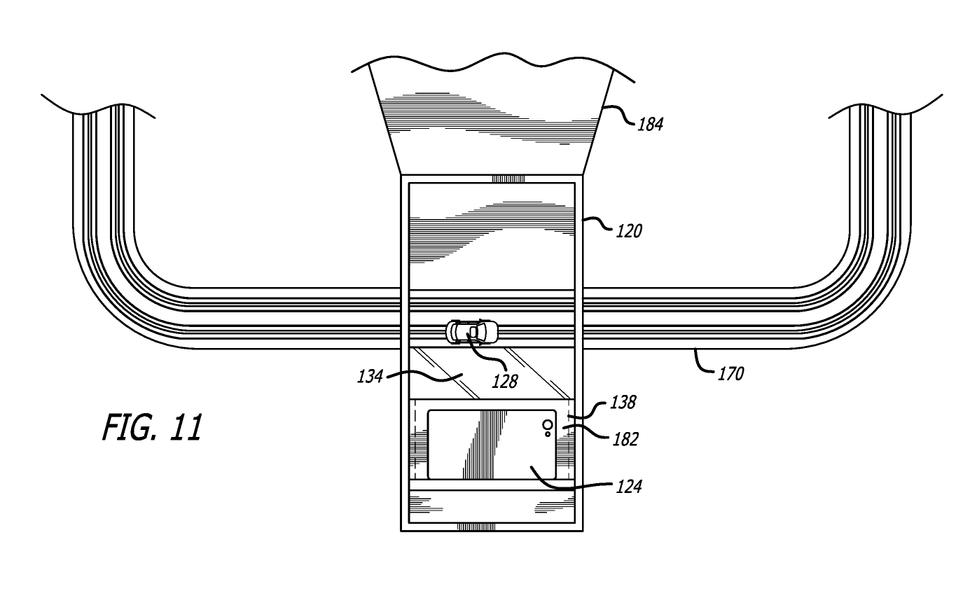

FIG. 12 shows an open top, side view of an exemplary embodiment of the Themed Holograph Theater 120 including the iPhone display device 124 mounted in the display device cradle 182 and placed within the cradle support structure 138. The depiction of FIG. 12 also shows one side 174 of the physical structure 122 of the Theater 120, which includes a graphic design 178 to decorate the exterior surface of the physical structure 122 in a racing theme consistent with the theme of the Theater 120, which is configured for use with a slot car racing system. It should be appreciated, however, that the graphic design 178 on the exterior surfaces of the physical structure 122 (or 22 in FIG. 1) can be altered for thematic consistency with any theme being played out in the Theater 120 (or Theater 20 of (FIG. 1). The physical structure 122 of the Theater 120 may even be sold with or separately from alternative graphic design 178 stickers or panels that can be affixed to the exterior surfaces of the physical structure 122 of the Theater 120. Accordingly, the Theater 120 may be decorated with any number of graphic designs to match the theme of the holographic display.

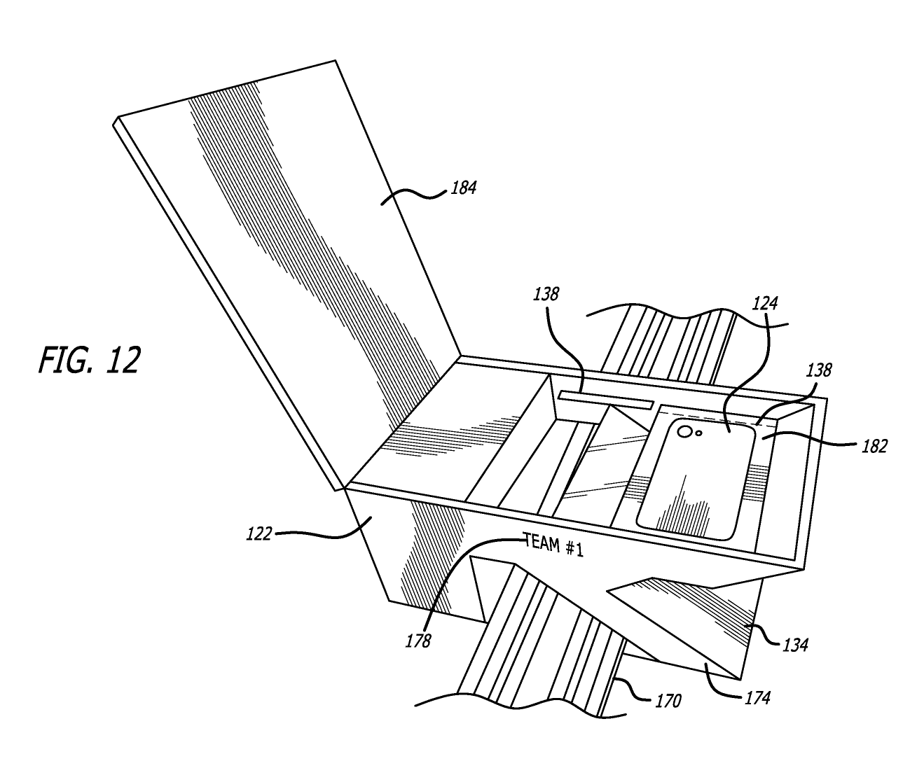

FIG. 13 shows an angled open top, side view of the Themed Holograph Theater 120 including the iPhone display device 124 mounted in the display device cradle 182, as in FIGS. 10-13, however the display device cradle 182 is positioned in an alternate location within the cradle support structure 138. In this alternate configuration, the front facing camera of the iPhone is positioned so that it does not “look through” the screen of the holographic image display 134, and only a portion of the screen of the iPhone may be used to project the images to appear as holograms onto the screen of the holographic image display 134.

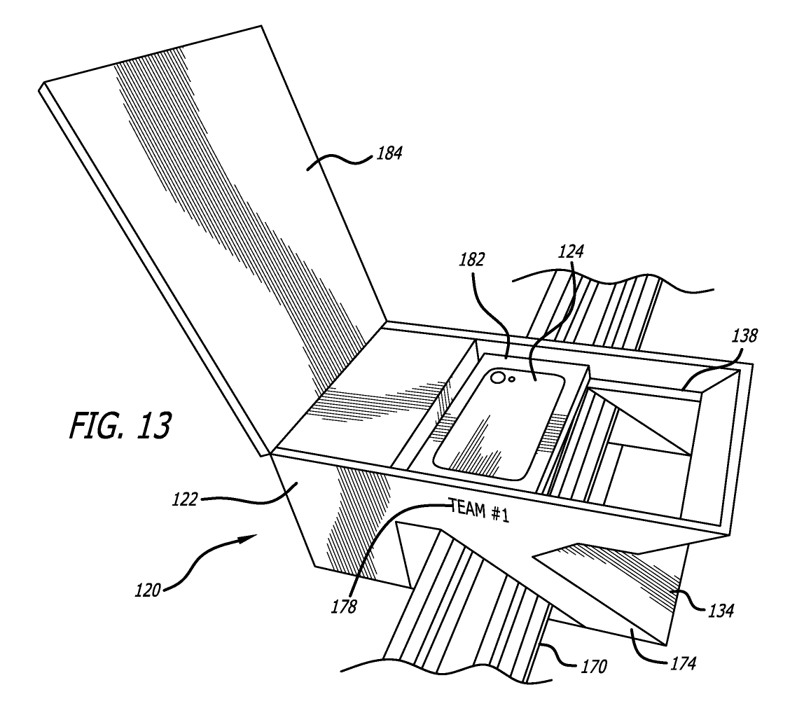

FIG. 14 shows an open top front view of the Themed Holograph Theater 120 with the iPhone display device 124 removed from the display device cradle 182, with the screen of the iPhone displaying the symbol to initiate the display of a graphic file, which a user would initiate immediately before placing the iPhone into the display device cradle 182.

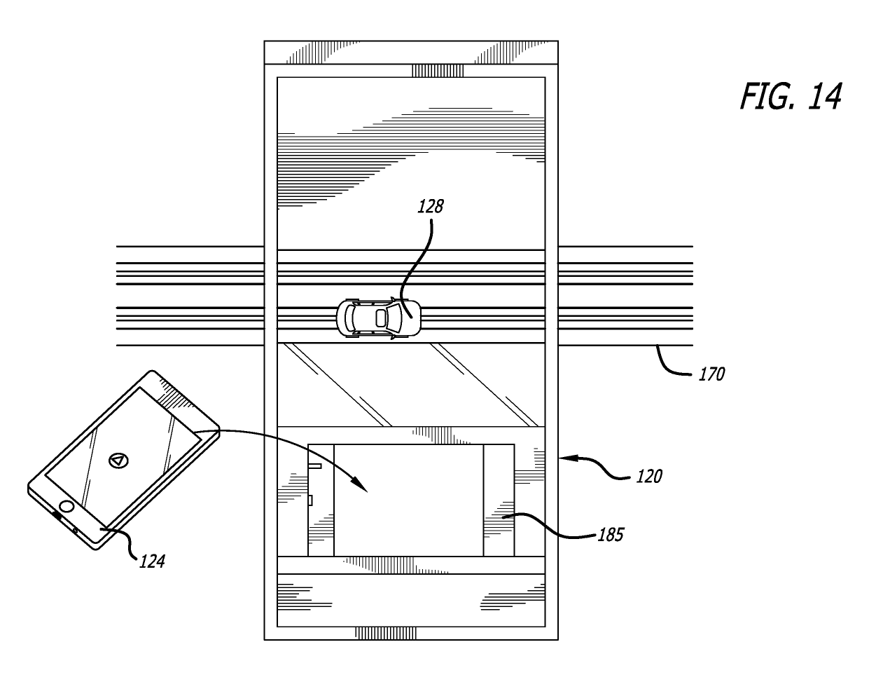

FIG. 15 shows a side view of the Themed Holograph Theater including the physical object represented by the race car 128 positioned on the slot car track 170 segment within the stage 130 of the Theater 120. At this side angle view, the screen of the holographic image display 134 is positioned behind a portion of the physical structure 122 of the Theater 120, and images projected on the holographic image display 134 will not be visible around the race car 128, as at this angle the viewer is not looking through the holographic image display [not shown] to see the race car 128.

FIG. 16 shows a perspective, side view of another version of the Themed Holograph Theater 220 including a display device 124 and a second display device 224 mounted in the canopy 180. The display device 124 is configured to project images onto the screen of the holographic image display 134 as in the configurations described above and depicted in FIGS. 1-15. The second display device 224 is configured and mounted to project images onto the backdrop 236. The second display device 224 can thereby be used to alter the backdrop to depict any number of background scenes, including live action or animated projections. FIG. 16 also depicts a toy 228, which is the physical object that triggers the holographic display, entering the stage 230. As depicted in FIG. 16, the toy 228 is a scaled reproduction of a car. As the toy 228 traverses the stage 230, it is identified by the system in any of the manners described herein, and the display device 124 may project holographic images and animation onto the toy 228, for example the light graphics on the toy 228 may be made to light up and project holograms, the toy 228 may be made to appear to be emitting smoke or lightning bolts holographic images 226 or light beams, and it may be made to appear to shake and otherwise appear animated. The system may utilize the camera of an iPhone being operated as the display device 124 to positionally track the movement of the toy 228 across the stage, providing a digital map to be used by the system to assure that the holographic display follows and locks onto the toy 228 functioning as the physical object in the Theater 220. The display device 124 and the second display device 224 are both controlled by the Theater system whereby from the perspective of a user or an audience viewing the Theater 220 through the screen of the holographic image display 134, the toy 228 may appear to be animated as it traverses the stage 230 in front of a backdrop depicting any number of themes or scenes, for example a desert scene, a cave scene, a forest scene or an urban setting.

FIG. 17 shows a detailed perspective view of the adjustable screen mounting device 200 and/or the cradle mounting device 202 of FIG. 9A and FIG. 9B. The mounting device 200 or 202 may include a screw or push-pin 304 that includes a head 306 and a shaft 308. The shaft 308 projects through the slots 210 in the end panels 174 and 176. The shaft 308 is configured to engage a clasp 310 having a base 312 and an orifice 314 to receive the shaft 308 of the screw or push-pin 304. The base 312 of the clasp 310 will abut against the interior surface of the respective end panel 174 or 176. The clasp 310 also includes a pair of extensions 316 projecting from the base 312 roughly forming an elongated “C” shape. The clasp 310 is preferably formed from a resilient rubber or plastic material that will allow the extensions 316 to flex away from each other to accommodate the insertion of an edge of the screen forming the holographic image display 24 (or 124), or alternatively an edge of the cradle 182. As depicted in FIG. 17, the edge of the screen forming the holographic image display 24 may include a support channel 318 that has an inner surface securing the edge of the screen of the holographic image display 24, and an outer surface configured to be secured within the clasp 310 between the pair of extensions 316. With this configuration, the angular orientation of the screen of the holographic image display 24 may be easily changed yet securely held in place. In addition, the position of the clasp 310 may be moved along the length of the slots 210 in the end panels 174 and 176, to horizontally adjust the positioning of the screen of the holographic image display 24, or the cradle 182. In addition, the configuration of the mounting devices 200 and 202 allows for easy assembly of the Theater structure as well as easy repair or replacement of the screen of the holographic image display 24, or the cradle 182.

FIG. 18 is a front perspective view of the Theater 120 including the slot car track 170 with two slot race cars 128. The display device 24 hidden inside of the canopy 180 is depicted as a smartphone, with the screen facing downward toward the stage 130. The smartphone display device 24 includes a camera that is capable of viewing the slot race cars 128 inside of the Theater 120 on the stage 130, as well as at certain locations within the field of view of the camera that are outside of the Theater 120, as illustrated by the camera field of view lines 145. The capability of identifying solid objects 28 such as the slot race cars 128 of FIG. 18 when they are outside of the Theater 120 allows the system to anticipate the entry of the solid objects 28 such as the slot race cars 128 onto the stage 130 so that the holographic display can be initiated around the object 28 and on the stage 130 as the physical object approaches and enters the Theater 120.

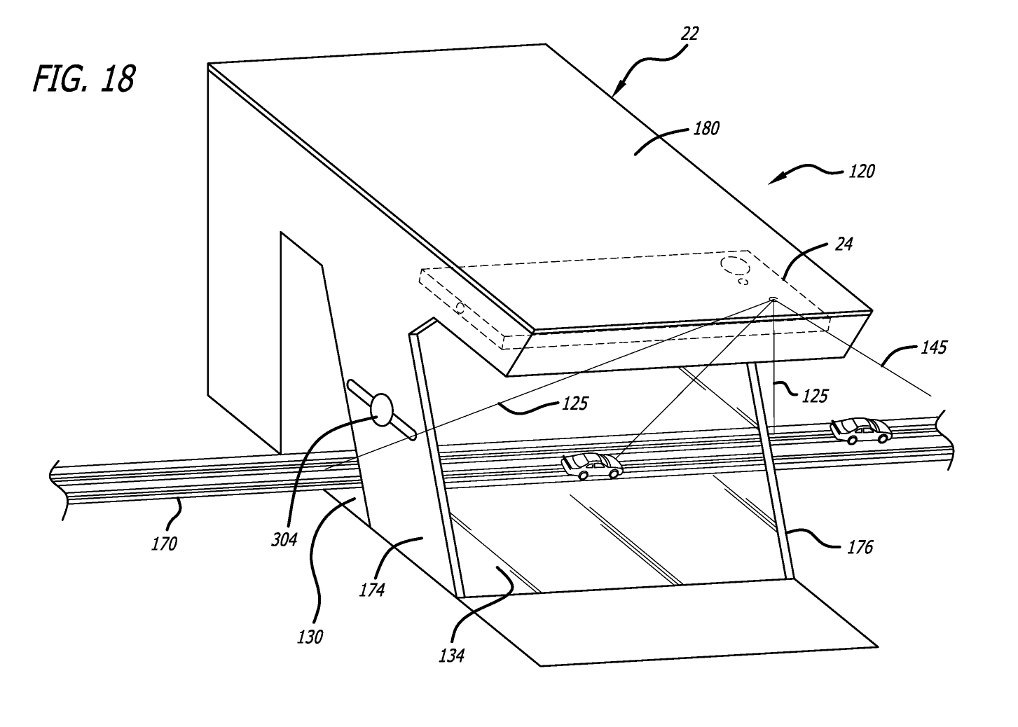

FIG. 19 is a front perspective view of the Theater 120 depicting a solid object in the shape of a miniature tree 218 moving across the stage of the Theater 120 with holographic images 226 appearing as decorations on the tree 218. The system is configured to track the tree as it passes through the stage 130 and to adjust the positioning of the holographic images 226 of the decorations projected onto the tree 218 so that they maintain their same position relative to the tree 218. By way of example, the system access the camera image data file of the smartphone, identifies the tree 218 as a triggering solid object inside of the Theater 120, detects movement of the solid object tree 218, detects the direction of the movement, determines the speed and any acceleration, and repositions the output to the image projector to match the holographic image projection to match the direction, speed and acceleration of the tree 218.

FIG. 20 is a front perspective view of an embodiment of the Theater 120 including a physical object in the form of a segment of a structure represented as an open side doll-house 328, positioned on the stage 130. The Theater 120 has the display device 24 in the canopy 180. The doll-house 328 may include at least one solid wall and floor, although multiple solid halls are represented. It should be appreciated that additional walls, floors and roof features may be provides as part of the holographic projection. Thus, for example, the elements depicting the roof of the doll-house 328 in FIG. 20 may be part of the holographic image projection, so that the holographic characters, depicted as floating ghosts 326, may be projected into the back portions of the rooms on the second floor of the doll-house 328. FIG. 20 is principally provided to illustrate the concept that the holographic projections or images such as the ghosts 326 may appear to pass through solid objects within the Theater 120. It should be appreciated that the configuration and implementation illustrated in FIG. 20 is merely representative of the theme and concept, and that the solid object can be virtually any item or structure and the holographic images projected into the stage 130 may be any item or embellishment to the scene being depicted within the Theater, and that the holographic images may be made to appear in, disappear into and even pass through solid objects.

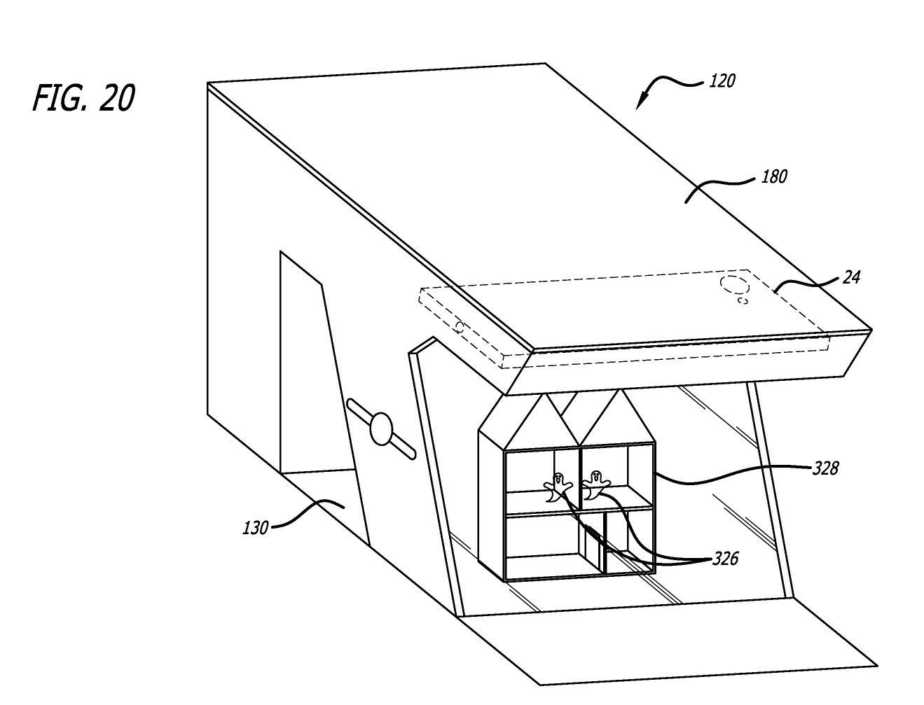

FIG. 21 is a front perspective view of an embodiment of the Theater 120 including a pair of display devices 124 and 125 that may independently or in combination project holographic images 126 onto the screen of the holographic image display 134, to appear on the stage 130 of the Theater 120. Providing the pair of display devices 124 and 125 allows the system to project more realistic three dimensional (3D) holographic images. Also, the pair of display devices 124 and 125 may combine their output to form one or more of the holographic characters, for example the human figures in FIG. 21, while only display device 124 (for example) projects the image of the holographic bird.

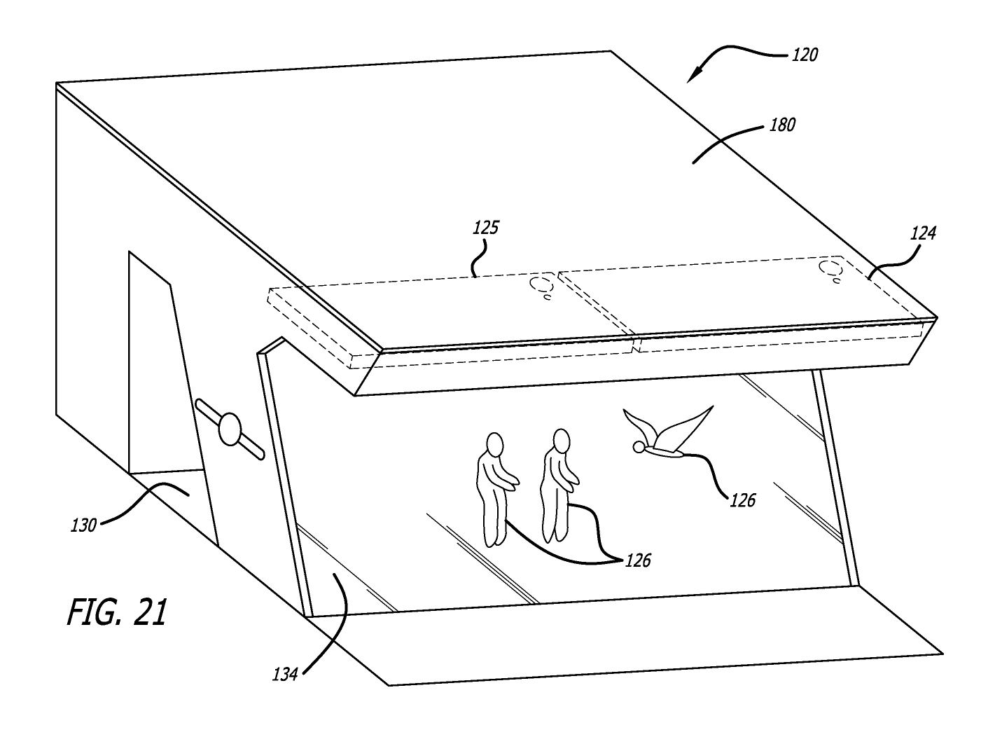

FIG. 22 is a front perspective view of an alternative embodiment of the Theater 120 of FIG. 21, including a pair of display devices 124, 125 that are mounted at different angles in the canopy 180 of the Theater 120, and thus at different angles with respect to the screen of the holographic image display 134. This configuration allows the projection of holographic images 126 and 127 that are at different depth locations on or above the stage 130.

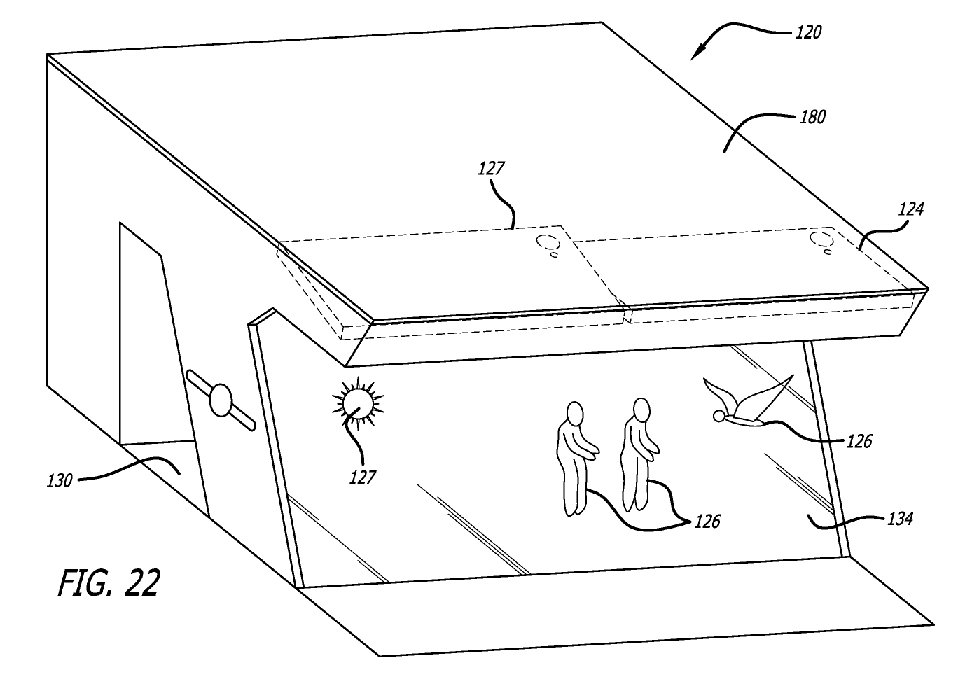

FIG. 23A is a depiction of an alternative configuration of a Theater 420 configured in the shape of a pyramid over an inverted pyramid with rhombus-shaped screens 434, as shown in FIG. 23B, on each of the eight sides. The theater of FIG. 23A includes a top display device 424 projecting downward and a bottom display device 425 projecting upwards. The Theater may include two or more supports 436 and a divider 438. The supports 434, 436 may preferably be positioned at the corners of the divider 438. The divider may be solid or it may include a cutout portion in its center under the top rhombus-shaped screens 434. One or both of the top display device 424 projecting downward and the bottom display device 425 projecting upwards, which may each be smartphones, tablet or pad computers, flat screen monitors or televisions, project images onto the rhombus-shaped screens 434 whereby holographic images appear within the space defined by the opposing pyramid shapes defined by the rhombus-shaped screens 434. As in the case of the Theaters 20 and 120 described above, the Theater 420 of FIG. 23 will identify solid objects placed on the divider 438, or in the space between the opposing top display device 424 and bottom display device 425, so that the projected holographic images interact with the physical object. This configuration of the Theater may be particularly adapted for demonstrating the proper use of a product or item, or for use in tradeshows to demonstrate how a product projected as a holographic image could interact with a physical object. FIG. 23B is provided to reflect the proportions of the respective rhombus-shaped screens 434, which has a base dimension of “6x”, a top dimension of “1x” and a height of “3.5x”, with the “x” being any common multiplier and dimension, for example 6 cm, 1 cm and 3.5 cm or 6 feet, 1 foot and 3.5 feet.

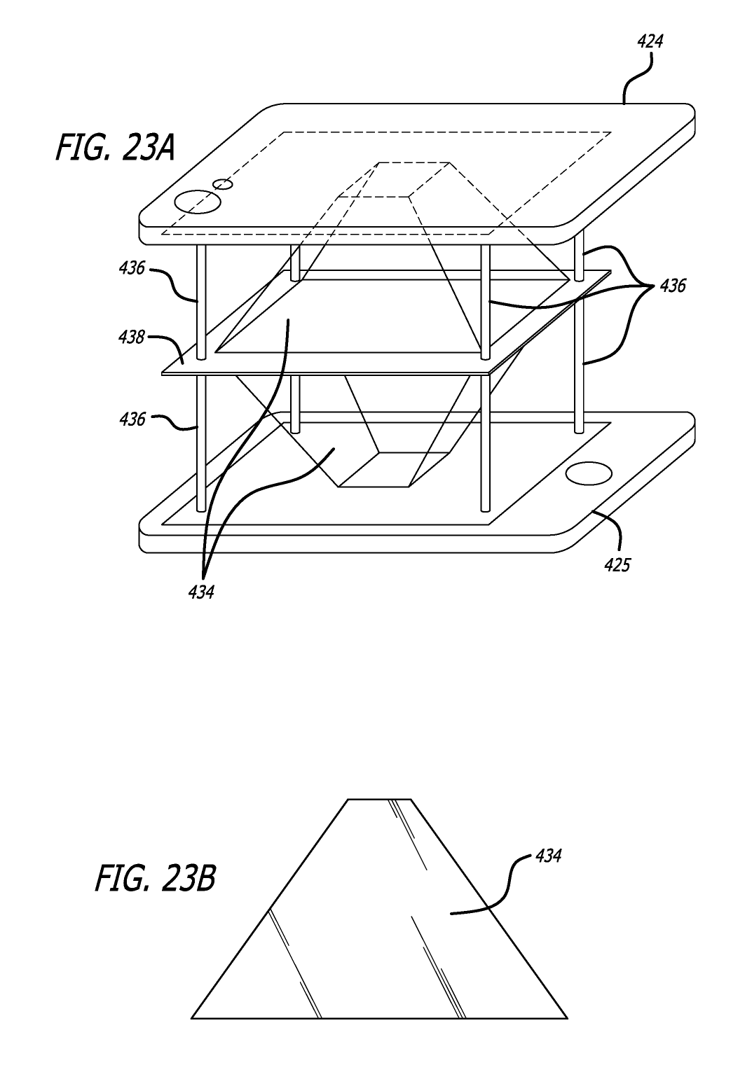

FIG. 24 is a schematic representation of another alternative configuration of an alternative projection and holographic screen configuration for a Theater of the present invention having multiple screens forming multiple sides of the stage 530 for the Theater. The configuration of FIG. 24 provides a top display device 524 as in FIG. 23, projecting downward and which may each be a smartphone, tablet or pad computer, flat screen monitor or television, that projects images onto the multiple screens 534a, 534b, 534c, 534d, . . . 534n, positioned at an angle to the screen surface of the display device 524. Images projected by the display device 524 appear as holographic images within the space defined by the multiple screens 534a through 534n, so that they may be viewed from several viewing angles. Alternatively, the screens for example 534b and 534c placed at the corners of the Theater may be solid (non-transparent) panels so that only the major sides 534a, 534d, and their opposing sides are configured as screens to provide holographic displays and the center stage 530 would be viewed through one of the four sides. Each of the screens 534a through 534n could be mounted at an interior angle of between 30 degrees to 60 degrees relative to the surface of the stage 530. Preferably, each of the screens 534a through 534n could be mounted at an interior angle of about 45 degrees relative to the surface of the stage 530.

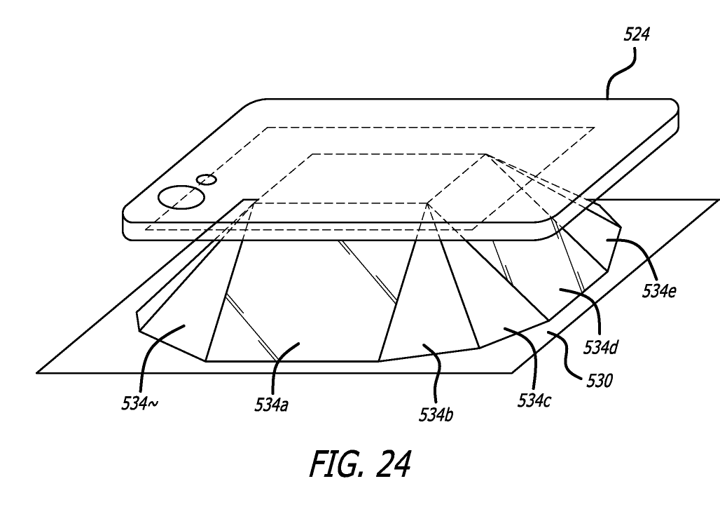

FIG. 25 schematically depicts a perspective view of components of an alternate configuration of the projection and screen components of the Theater of the present invention. In FIG. 25, there are two display devices 24 and 25, with screens facing upwards to project onto holographic image screens 534, 535 positioned over the respective display devices 24 and 25 at an angle. The angle may be between thirty degrees and sixty degrees, but preferably about forty five degrees. The holographic image screens 534, 535 may be a portion of a single sheet of material having a vertical forward edge 540, a horizontal base 542 and a transition bend 544 into the holographic image screens 534 (or 535). The display devices 24 and 25 may be positioned on the horizontal base 542 under the holographic image screens 534 (or 535), and hidden by the forward edge 540. The two display systems may be used alone or in combination to project holographic images into the perceived space behind the holographic image screens 534 (or 535).

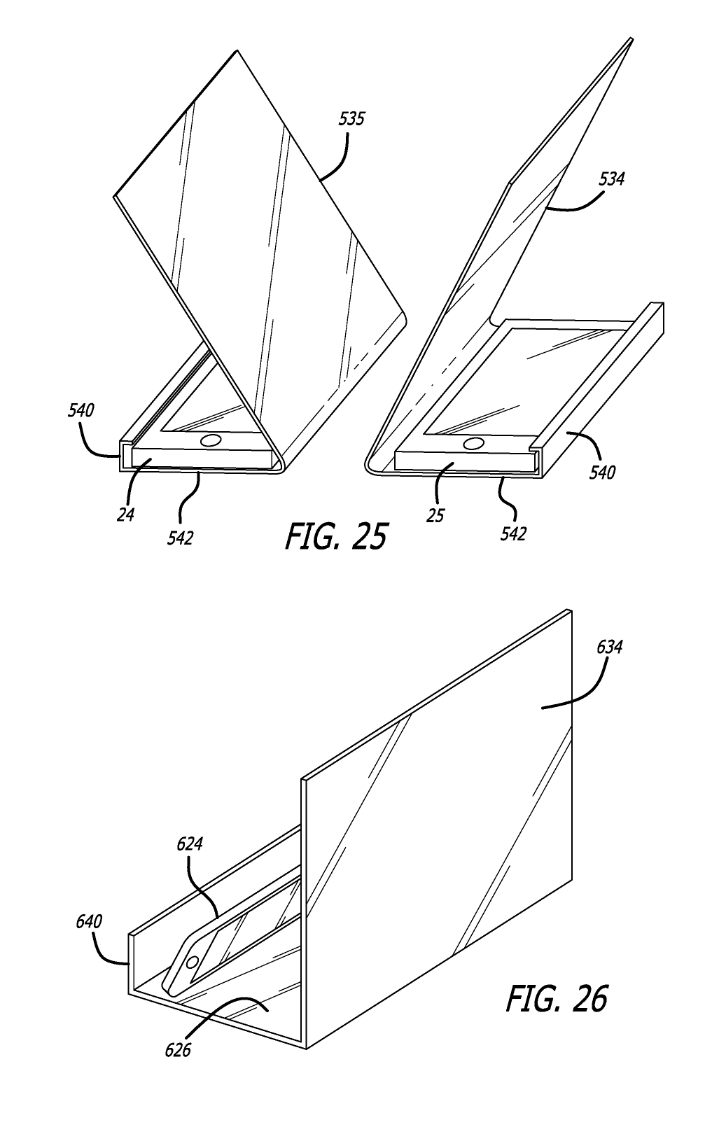

FIG. 26 schematically depicts a perspective view of another alternate configuration of the display assembly that may be used in the Theater of the present invention. In FIG. 26, the display device 624 is positioned at an angle tilting over a horizontally positioned mirror 626, that reflects the image projected by the display device up onto a vertical screen 634. A forward edge 640 both hides and provides a mounting system or cradle (not shown) for the display device 624. This projection system may be placed in front of the Theater 20 of FIG. 1 or Theater 120 of FIG. 2, to replace or augment the respective display devices 24, 124 therein.

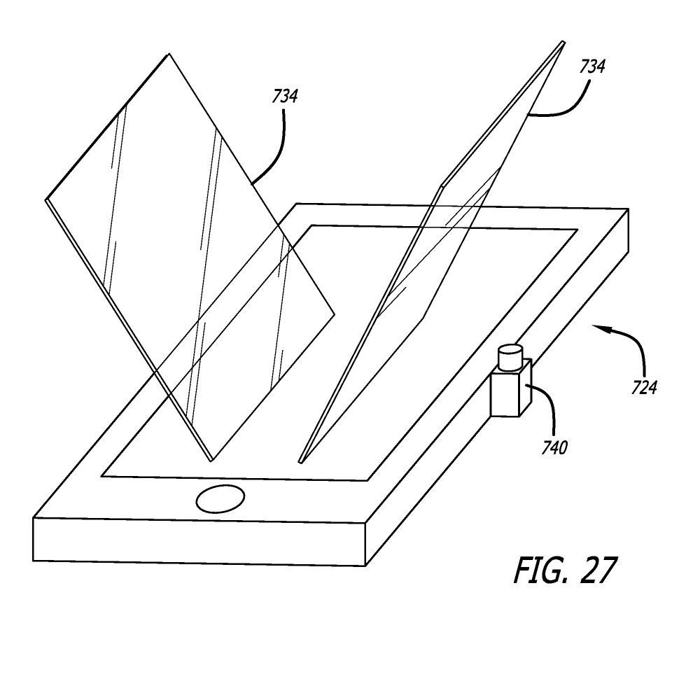

FIG. 27 schematically depicts a perspective view of another alternate configuration of the display assembly that may be used in the Theater. In the embodiment of FIG. 27 display device 724 is laid flat and two or more screens 734 are positioned above the display device 724 at an interior angle of, for example forty-five degrees (45°), The screens 734 would be supported by a surrounding structure (not shown in FIG. 27) to maintain their respective positions. The configuration would further include a scanner device 740 that may be positioned at an edge of the display device 724. This system could be used, for example, in the Theater 20 of FIG. 1 or the Theater 120 of FIG. 2 with the placement of the display device 724 lying flat on the respective stage 30 or 130 of FIGS. 1 and 2. The screens 734 could be oriented as shown in FIG. 27 to form a “V” shape wherein the holographic images would appear between the respective screens 734 from the perspective of a viewer at either long side of the display device 724. Alternatively, the screens could be positioned in parallel planes whereby a viewer on one side would see holographic images appearing at different depths of field locations behind the respective screens 724 and above the display device 724.

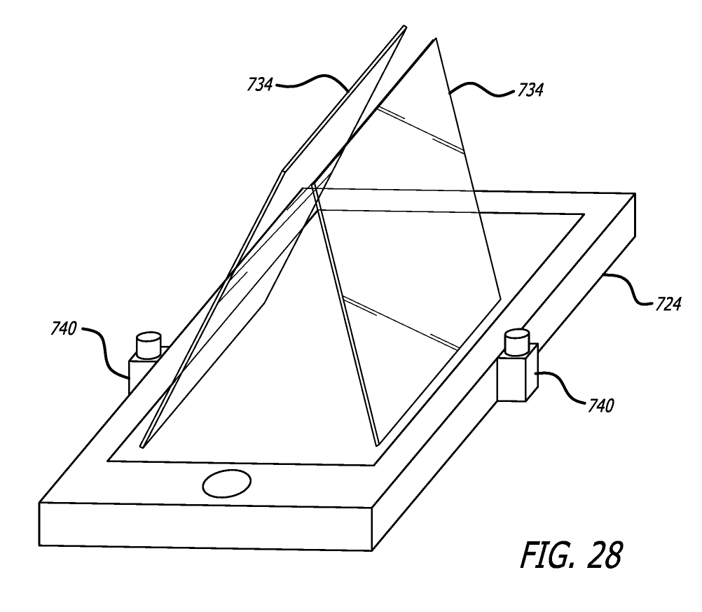

FIG. 28 schematically depicts a perspective view of another alternate configuration of the display assembly of FIG. 27 that may be used in the Theater. In the configuration of FIG. 28, the respective screens 724 are positioned with a bottom edge proximate the long edges of the display device 724 and the upper edges of the screens 724 converging towards each other to form triangle shape with the display device 724 serving as the base of the triangle. In this configuration, the screens 274 may have the same or differing heights and thus the triangle shape may or may not be an equilateral triangle.

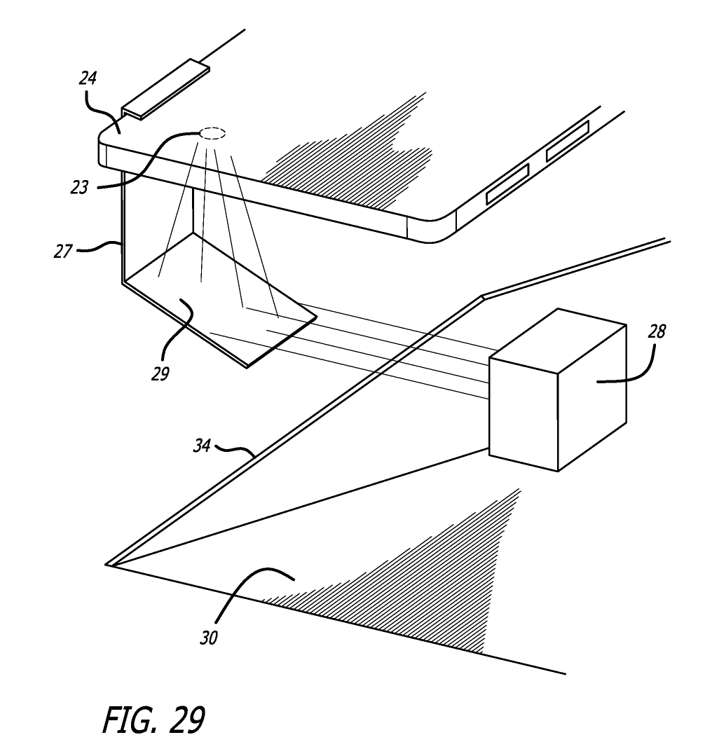

FIG. 29 schematically depicts a perspective view of another alternate configuration that may be used in the Theater of FIG. 1 and FIG. 2. FIG. 29 depicts a mirror bracket 27 and a small mirror 29 which may be secured to the smartphone display device 24 of FIG. 1 (or FIG. 2). The mirror 29 is secured by the bracket 27 in a position relative to the camera 23 of the smartphone display device 24, so that the camera 23 may image reflections of a solid object 28. This configuration allows the camera 23 to “see” a solid object 28 and cause the display device 24 to project a hologram at a different angle where the solid object 28 may otherwise be out of range of the camera 23.

FIG. 30 schematically depicts a perspective view of another alternate configuration of the display assembly that may be used in the Theater 20 of FIG. 1 (or FIG. 2). In FIG. 30 a projector type display device 24 and a scanner or camera 23 are positioned at the leading edge of the top or canopy 80 of the Theater 20. A physical object 28, depicted by way of example as a small tree in FIG. 30, is detected by the scanner or camera 23 and triggers the projection of an image downward onto a mirror 31 at the forward edge of the stage 30. The projected image reflects off of the mirror 31 up onto the screen of the holographic image display 34, which is aligned at an acute angle to the mirror 31, and appears as a holographic image 26. In the depiction of FIG. 30, the holographic image 26 is an image of the sun over the solid object 28 tree.

FIG. 31 schematically depicts a perspective view of another alternate configuration of the display assembly that may be used in the Theater 120 of FIG. 2. In the embodiment of FIG. 31, two display devices 124 and 125, respectively, are positioned in the canopy 180 of the Theater 120. One of the display devices 124 senses the physical object 128, a doll or even a live person, and projects the holographic image 126, the dog following or playing with the physical object 128, onto the screen of the holographic image display 134. The second display device 125 may be used to project background scenery 137 onto the backdrop 136 of the Theater 120. As depicted in FIG. 31, the background scenery 137 may be a mountain range or other outdoor scene. Of course, any background scenery 137 may be displayed. In addition, the respective display devices 124 and 125 may be connected either physically with wires (not shown) or preferably wirelessly for example using BLUETOOTH technology, to coordinate the respective imagery. As in the embodiments discussed above, the projected holographic imagery may include imagery to animate the physical object 128.

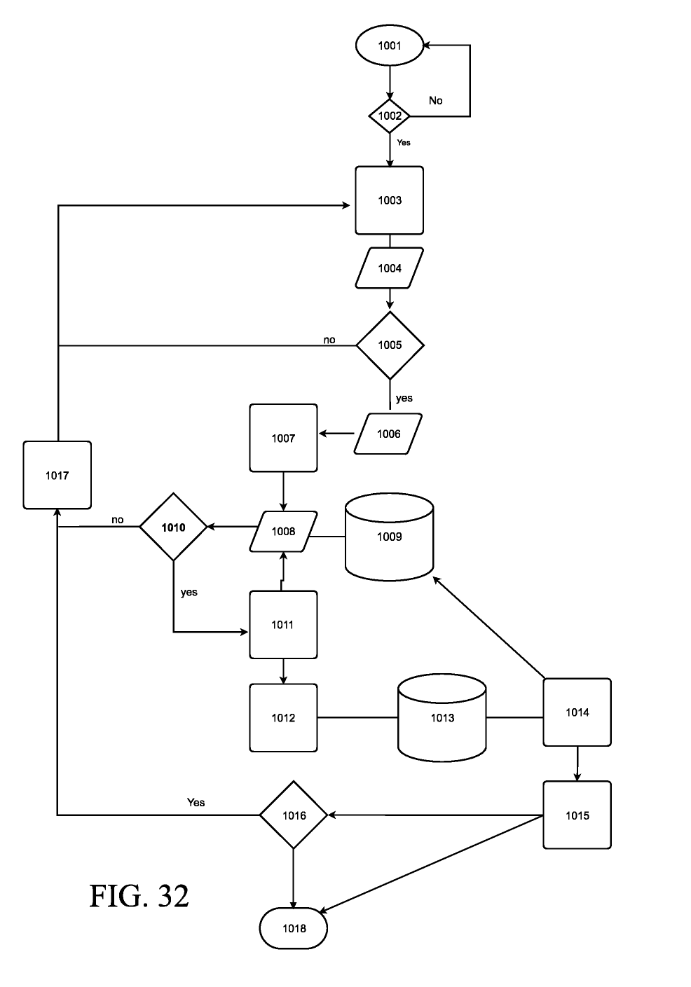

FIG. 32 provides an exemplary flowchart for the logic and program to control the holographic media output for the Themed Holographic Theater of the present invention. The program is initiated at the start box at step 1001. At step 1002, the program executes a decision “Is the scanner active?” If the conclusion is “no” the program loops back to step 1001. If the conclusion is “yes” the program moves to step 1003, access input scanner. As discussed above, the input signal may come from a number of types of scanner devices contemplated by the present invention, including an optical scanner, RFID sensor, barcode scanner, digital camera, Bluetooth and Wifi. At step 1003, the program queries the respective type of scanner being used to obtain data concerning the physical object that will trigger the holographic image functionality.

Upon receipt of the scanner input, the program proceeds to step 1004, determination of the scan input source type. At this step 1004, the program analyzes what it has received from the scanner in step 1003, to determine if it has received 2D images, 3D objects, RFID tag signal, Bluetooth data or Wifi data. Next, at step 1005, the program queries “Has the scanner hardware received input data?” If the conclusion is “no” the program loops back to step 1003. If the conclusion is “yes” the program proceeds to step 1006, to analyze the data gathered by the scanner hardware and determine if the data includes: physical object identification data, images, color indicator(s), lighting contrasts, distance of physical object, position of physical object.

Based on the type of data analyzed at step 1006, the program at step 1007 executes a search of a trigger object database including a plurality of files with characterizing information for each of the known physical objects that may trigger the holographic media display. The characterizing information in the trigger object database may include information about the size, shape, color, and other physical characteristics of the physical object that may not be available from an RFID or barcode scanner, which only provides for example a reference number used to search the trigger object database.

After the program has accessed all of the necessary characterizing information for the physical object trigger, the program at step 1008 queries the augmented reality or output media database 1009 to obtain the media file to display within the Theater. The media database 1009 includes the augmented reality and/or holographic imagery trigger object data file parameters. The types of data assigned to objects within the media database may include: assigned hologram media identification, trigger object details including physical traits, size, color, weight, dimensions, distance from scanner and location within the recognition area.

After the media database query of step 1008, the program then proceeds to step 1010 to query “does the scanned data match a known input for triggering an augmented reality or holographic image output?” If at step 1010 the determination is “yes” the program moves to step 1011 where the program updates the physical object data retrieved from the within the output media database 1009 with the scanner data parameters for output play-back of the holographic media.

The output of step 1011 may be both forwarded to step 1012 to execute a search of a media playback server or stored memory database at step 1013 to obtain assigned hologram media based on the identification from the output media database 1009 assignment, and also forwarded to the program at step 1008 to update the program and increment the next output from 1009. For example, in the race car themed Theater described above, the system may recognize that the same race car has entered the Theater a second (or third time, etc.) and instead of running the same media display output the program increments to a second or third media output data file to generate a new and different holographic media display.

After proceeding through the access of the media playback server or stored memory database at step 1013, the program continues to step 1014 to process the playback media for optimal projection output based on the scanner input data from step 1006 controlling the output position and angle to match the trigger physical object's characterization data and its position within the hologram Theater. The playback parameter data is temporary stored within the output media database 1009. From step 1014, the program proceeds to step 1015 to execute the playback media call to send the selected and modified media to the projector of the Theater at step 1018, and initiate the play of the media to produce the holographic imagery within the Theater.

Upon execution of the step 1015 the program also executes a query at step 1016 to check to see if the scanner has updated the input data. If the response is “yes” the program proceeds to step 1017 to then loop back to step 1003 to check updated input of scanner data. If the answer is no the program continues to step 1018, and upon completion of the play of the media file the program ends, and effectively returns to step 1001.

Also, if at step 1010 the determination of the query: “does the scanned data match a known input for triggering an augmented reality or holographic image output?” was “no” the program proceeds to step 1017 which initiates a loop back to step 1003 to obtain updated scanner input data.

The foregoing program flow logic and the flow chart of FIG. 32 are intended as being exemplary of the logic of a program to control the Theater. The program may be loaded and executed on a standard desktop or laptop or tablet computer or smartphone. The program may also be loaded and executed on a on a server. The program may be provided as an application for execution on or by one of the foregoing types of devices, and the application may be provided with a limited trigger object database as well as a number of hologram media files within an output media database that may be downloaded and stored with the application on the computer or smartphone device. It should further be appreciated that the implementation of the steps and subroutines discussed above will be substantially dependent upon the hardware selected for the components of the Theater, including for example the particular type of scanner and the manner of identifying the target physical object. Subroutines that may be needed to implement any step of the foregoing described program are presently available and accessible to programmers having a reasonable degree of skill and experience in computer programing. Detailing each of the subroutines for programming each of the dozens if not hundreds of possible combinations of hardware devices that may be incorporated is therefore not practical. Notwithstanding, the foregoing description of the program logic in combination with the detailed description in the specification sufficiently detail the underlying concept of identifying a physical object within a Theater and creating a holographic media display output that to a viewer appears to interact with the physical object in the Theater.

Those skilled in the art will readily appreciate that the disclosure herein is meant to be exemplary and actual hardware and software components as well as physical parameters including shapes and materials depend upon the specific application for which the present invention is provided. Accordingly, the foregoing embodiments are presented by way of examples while the scope of the invention is defined by the appended claims and equivalents thereto.

What is claimed is:

1. A holograph theater system comprising:
a display theater including a structure to define a stage and at least one holographic media screen;
a monitor device to obtain and output data concerning a physical object within the stage of the display theater;
a projector to project images onto said holographic media screen; and
at least one computer control program receiving said data from said monitor device sufficient to identify said physical object within the stage of the display theater, identify the physical object based on said monitor device data and generate output control signals to said projector to cause the projection of images onto said holographic media screen which images are made to appear to be interacting with the physical object.

2. The holographic theater system of claim 1, wherein said holographic media screen of said display theater is selected from the group consisting of: reflective glass, clear Lexan, acetate, clear polyester, clear polycarbonate, and clear plastic transparent material.

3. The holographic theater system of claim 1, wherein said monitor device of said display theater is selected from the group consisting of: a digital camera, a digital scanner, a three dimensional scanner, a barcode scanner, a universal product code scanner, quick read scanner, and a radio frequency identification device scanner.

4. The holographic theater system of claim 1, wherein said projector of said display theater is selected from the group consisting of a liquid crystal display screen, a light emitting diode display screen, a movie projector, a smartphone, a tablet computer, a television and a monitor.

5. The holographic theater system of claim 1, further comprising a computing system programmed with said computer control program and said computing system having data storage and one or more programs to access media from said data storage and control the output to the projector device to project the media within said display theater.

6. The holographic theater system of claim 1, wherein said projector's projection of images comprises output media selected from the group consisting of text, graphics, video, image, audio, website, and smartphone applications.

7. The holographic theater system of claim 1, further comprising a second projector to project output media onto at least a portion of said structure defining said stage of said display theater.

8. The holographic theater system of claim 1, wherein said display theater further comprises a canopy structure to facilitate mounting of said projector above said stage of said display theater.

9. The holographic theater system of claim 1, wherein said structure of said display theater further comprises a holographic image display mounted between two end panels of said structure defining said stage, said holographic image display extending up from a front edge of said stage to a canopy at an acute angle to the surface of the stage formed in the range of about thirty degrees to seventy five degrees.

10. The holographic theater system of claim 1, further comprising a plurality of holographic media screens allowing viewing of the projection of holographic images on said stage of said theater from at least two different angles.

11. The holographic theater system of claim 1, further comprising a second projector to project images onto said holographic media screen or a second holographic media screen within said stage of said theater.

12. A holograph theater system comprising:
a display theater including a structure to define a stage, said structure including at least two holographic media screens;
a monitor device to obtain and output data concerning a physical object proximate said stage of said display theater;
at least one display device to project inverted images onto at least one of said at least two holographic media screens, whereby said projected images are inverted to appear as holographic images within said stage, said holographic images being made to appear to interact with said physical object.

13. The holographic theater system of claim 12, further comprising a first display device to project images onto at least one of said at least two holographic media screens and a second display device to project images onto at least one of said at least two holographic media screens.

14. The holographic theater system of claim 13 wherein said first and second display devices project holographic images produced from live action video, animation, or computer generated graphics.

15. A holograph theater for interactive use with a user's device selected from the group consisting of a smartphone, tablet computer, laptop computer, flat or curved screen television or monitor, the user's device having a control program to access camera image data of said user's device and identify a physical object located in the display theater to control said user's device projection of images appearing to interact with the physical object in the holograph theater, said holograph theater comprising:
a structure including a stage area having backdrop, a pair of end panels and overhanging canopy;
a holographic image display mounted between said end panels of said structure defining said stage area, said holographic image display extending up from a front edge of said stage to said canopy at an acute angle to the surface of the stage formed in the range of about thirty degrees to seventy five degrees; and
a cradle for supporting said user's device in said canopy of said structure and position said user's device in a location whereby images on a display of said user's device are projected onto said holographic image display and appear as 2-dimensional or 3-dimensional holographic images.

16. A theater piece to be used with a holographic theater system having a scanner, a holographic projector, a display theater including a holographic media screen and a control program for the holographic theater system, said theater piece comprising:
a physical object characterized by an identification characterizer selected from the group consisting of a bar code, uniform product code, a quick read code, a radio frequency identification device or an image code, that may be detected by said scanner to then identify an associated data file in a memory associated with the Theater system, the data file having information concerning the physical characteristics of the physical object (size, shape, color, surface features, etc.), that may be incorporated into the control of the holographic media projection.

17. A theater piece to be used with a holographic theater system having a scanner, a holographic projector, a display theater including a holographic media screen and a control program for the holographic theater system, said theater piece comprising:
a solid 2D or 3D object having an associated object characterizing data file that may be loaded to a computer memory and accessed by a control program for the holographic theater system; and
a theater piece identifier incorporated in or on said theater piece and identifiable by said theater scanner to allow retrieval of said object characterizing data file; said theater piece identifier selected from the group consisting of: a barcode, a uniform product code (UPC) code, a quick response (QR) code, and a radio frequency transponder.

18. An application program for a smart phone or personal computing device to be used as a display device for a holographic theater system, wherein said theater system includes a scanner, a display theater including a holographic media and a computer having a control program for the holographic theater system, the application program comprising: accessing data from a scanner, identifying a physical object and its characteristics based upon said data from said scanner and information in a physical object database, accessing media specifically associated with said physical object and its characteristics, updating said media with said physical object's characteristics and generating output media combining said accessed media and said physical object's characteristics to initiate the display of holographic images appearing to interact with said physical object, said application program causing said smart phone or personal computing device to be used as a display device for a holographic theater system to project imagery unto a holographic media to generate holographic images within the theater.
